(19) United States
(12) Patent Application Publication
(10) Pub. No.: US 2026/0179147 A1
(43) Pub. Date: Jun. 25, 2026

(54) FINANCIAL PLANNING SYSTEM AND METHOD

(71) Applicant: Impacting Advisors LLC, Glastonbury, CT (US)

(72) Inventor: Michael GROSSMAN, East Otis, MA (US)

(21) Appl. No.: 19/422,851

(22) Filed: Dec. 17, 2025

Related U.S. Application Data
(60) Provisional application No. 63/736,759, filed on Dec. 20, 2024.

(51) Int. Cl. G06Q 40/06

(52) U.S. Cl. CPC G06Q 40/062; G06Q 40/064

(57) ABSTRACT

Systems, methods, and computer program products are presented for receiving and evaluating financial data of a client, creating classes for the financial data, and generating financial planning recommendations and financial plans including calculations defining an allocation of funds between the classes to maintain or achieve the client's financial goals. The system includes a server and user devices, each having a processor and memory. The user devices communicate with the server over a network. The server and the user devices cooperate to calculate and provide visibility to a client's finances, permit simulation of performance when an attribute of the client's financial data is revised and to provide a measurement tool of performance and of client's decision-making process. The system employs graphical user interfaces that allow an interactive review and modification of a client's financial data during meetings between the client and one or more of their financial planning advisers.

### CROSS-REFERENCE TO RELATED APPLICATIONS

This application is a non-provisional application of, claims benefit of, and priority under 35 U.S.C. § 119(e) to, co-pending and commonly owned U.S. Provisional Patent Application Ser. No. 63/736,759, filed on Dec. 20, 2024, titled “FINANCIAL PLANNING SYSTEM AND METHOD,” which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### FIELD OF THE INVENTION

The present disclosure relates to systems, methods, and computer program products for financial planning and, in particular, to systems and methods that provide relatively simple, streamline, and highly collaborative processes for evaluating a client's financial data, creating classes for the financial data, and generating financial planning recommendations and a financial plan, in some embodiments, in real-time during financial advisor-client meetings, including a calculated allocation of funds between the classes to maintain and achieve one or more financial planning goals of the client.

### BACKGROUND OF THE INVENTION

This description of related art is provided to generally present context of the present disclosure. Unless otherwise indicated, the information described in this section is not prior art to the claimed invention of this patent document and is not admitted to be prior art by inclusion therein.

To achieve personal and financial objectives, it is well-known for individuals to seek a relationship with one or more financial advisors. Financial advisors typically establish a relationship with their financial planning clients, regularly consulting with each of the clients to assess their changing financial position, and to help each client achieve their financial goals and objectives. Financial planners often use computer systems to assist with the financial planning process. Accordingly, the inventor has discovered that there is a need for improved computer systems and methods for financial planning, including retirement planning, to provide increased visibility to financial trends to facilitate subsequent financial planning recommendations from financial advisors to achieve financial goals of their clients.

### SUMMARY OF THE DISCLOSURE

The present disclosure describes, in one aspect, a system for financial planning. In some embodiments, the system includes a server having a server processor and a server memory operatively coupled to the server processor. The server memory stores server instructions executable by the server processor. In some embodiments, the system also includes one or more user devices, operable by one or more users of the system. Each of the one or more user devices includes a user device processor, a user device memory operatively coupled to the user device processor, and a user device display operatively coupled to the user device processor and exhibiting a plurality of graphical user interfaces (GUIs) thereon. The one or more user devices communicates with the server over a communication network. Each of the user device memory stores user device instructions executable by the user device processor.

In some embodiments, the server processor, when executing the server instructions, is configured to receive financial data of at least one client, to evaluate the received financial data, and to create at least one of one or more classes of assets, one or more classes of liabilities, one or more classes of income, one or more classes of expenses, or financial goals for the at least one client from the received financial data. The server processor, when executing the server instructions, is further configured to store, within the server memory, a client profile for the at least one client, where the client profile includes the at least one of the created classes of assets, liabilities, income, expenses, or financial goals for the at least one client. The server processor, when executing the server instructions, is also further configured to generate one or more initial financial planning recommendations and an initial financial plan for the at least one client, where the initial financial planning recommendations and the initial financial plan include calculations of income and spending over a specified period of years, calculations of an allocation of funds between the created classes of assets, liabilities, and expenses within the initial financial plan to at least one of maintain or achieve the financial goals of the at least one client, and to store the generated one or more initial financial planning recommendations and the initial financial plan in the client profile. The server processor, when executing the server instructions, is also further configured to update the stored client profile for the at least one client upon receipt of at least one of new values for the at least one of the created classes of assets, liabilities, income, expenses, or financial goals for the at least one client or a request generated by one of the one or more user device processors by recalculating the income and spending over the specified period of years and recalculating the allocation of funds to generate updated financial planning recommendations and an updated financial plan based on the new values to at least one of maintain the created financial goals or new financial goals for the at least one client. The server processor, when executing the server instructions, is further configured to host the plurality of GUIs for monitoring and updating at least one of the stored client profile or the one or more initial and updated financial planning recommendations and the initial and update financial plan for the at least one client.

In some embodiments, the user device processor, when executing the user device instructions, is configured to monitor, by invoking one of the plurality of GUIs, the client profile and progress of the one or more initial and updated financial planning recommendations and the initial and updated financial plan toward the created financial goals or the new financial goals for the at least one client, and to update, by invoking one of the plurality of GUIs, a value of one or more of the created classes of assets, liabilities, income, expenses, or financial goals and generate a request to the server processor to update the stored client profile to reflect the updated value. The user device processor, when executing the user device instructions, is further configured to simulate performance of the client profile based on changing at least one attribute of at least one of the created classes of assets, liabilities, income, or expenses or a duration of the specified period of years, and based on the simulated performance, to modify the one or more initial or updated financial planning recommendations and the initial or updated financial plan with the at least one changed attribute to at least one of maintain the created financial goals or the new financial goals for the at least one client. The user device processor, when executing the user device instructions, is also further configured to generate the request to the server processor to update the stored client profile for the at least one client to include the modified one or more initial or updated financial planning recommendations and the initial or updated financial plan.

The present disclosure also describes, in another aspect, a computer implemented method for financial planning. The method comprises receiving, by a server computing device, financial data of at least one client, evaluating, by the server computing device, the received financial data and creating at least one of one or more classes of assets, one or more classes of liabilities, one or more classes of income, one or more classes of expenses, or financial goals for the at least one client from the received financial data. The method also includes storing, within a server memory operatively coupled to the server computing device, a client profile for the at least one client, the client profile including the at least one of the created classes of assets, liabilities, income, expenses, or financial goals for the at least one client, generating, by the server computing device, one or more initial financial planning recommendations and an initial financial plan for the at least client, the initial financial planning recommendations and the initial financial plan including calculations of income and spending over a specified period of years, calculations of an allocation of funds between the created classes of assets, liabilities, and expenses within the initial financial plan to at least one of maintain or achieve the financial goals of the at least one client, and storing the generated one or more initial financial planning recommendations and the initial financial plan in the client profile. The method also includes updating, by the server computing device, the stored client profile for the at least one client upon receipt of at least one of new values for the at least one of the created classes of assets, liabilities, income, expenses, or financial goals for the at least one client or a request, generated by one or more user computing devices, by recalculating the income and spending over the specified period of years and recalculating the allocation of funds to generate updated financial planning recommendations and an updated financial plan based on the new values to at least one of maintain the created financial goals or new financial goals for the at least one client, and hosting, by the server computing device, a plurality of GUIs for monitoring and updating at least one of the stored client profile or the one or more initial and updated financial planning recommendations and the initial and update financial plan for the at least one client.

The method also includes monitoring, by at least one of the one or more user computing devices, by invoking one of the plurality of GUIs, the client profile and progress of the one or more initial and updated financial planning recommendations and the initial and updated financial plan toward the created financial goals or the new financial goals for the at least one client, and updating, by the at least one user computing device invoking one of the plurality of GUIs, a value of one or more of the created classes of assets, liabilities, income, expenses, or financial goals and generating a request to the server processor to update the stored client profile to reflect the updated value. The method also includes simulating, by the at least one user computing device, performance of the client profile based on changing at least one attribute of at least one of the created classes of assets, liabilities, income, or expenses or a duration of the specified period of years, based on the simulated performance, modifying by the at least one user computing device the one or more initial or updated financial planning recommendations and the initial or updated financial plan with the at least one changed attribute to at least one of maintain the created financial goals or the new financial goals for the at least one client, and generating, by the at least one user computing device, the request to the server computing device to update the stored client profile for the at least one client to include the modified one or more initial or updated financial planning recommendations and the initial or updated financial plan.

### BRIEF DESCRIPTION OF THE DRAWINGS

The features and advantages of the present disclosure are better understood when the Description of the Preferred Embodiments given below is considered in conjunction with the figures provided herein and illustrating exemplary embodiments, wherein:

FIG. 1 illustrates an example, non-limiting, schematic block diagram of a financial planning system, according to some embodiments;

FIGS. 2A to 2C depict an exemplary Balance Sheet (BAL) graphical user interface (GUI) implemented within the financial planning system of FIG. 1, according to some embodiments;

FIGS. 3A and 3B depict an exemplary Unique Possibilities Solution (UP) GUI implemented within the financial planning system of FIG. 1, according to some embodiments;

FIGS. 4A and 4B depict an exemplary Net Present Value (NPV) Solution GUI implemented within the financial planning system of FIG. 1, according to some embodiments;

FIG. 5 depicts an exemplary Allocation Blueprint (AB) GUI implemented within the financial planning system of FIG. 1, according to some embodiments;

FIG. 6 depicts an exemplary Accounts Held Elsewhere (AHE) GUI implemented within the financial planning system of FIG. 1, according to some embodiments;

FIGS. 7A and 7B depict an exemplary Strategic Guide GUI implemented within the financial planning system of FIG. 1, according to some embodiments;

FIGS. 8A and 8B depict an exemplary Stock Appreciation Rights (SARS) GUI implemented within the financial planning system of FIG. 1, according to some embodiments;

FIG. 9 depicts an exemplary Restricted Stock Awards (RSUS) GUI implemented within the financial planning system of FIG. 1, according to some embodiments;

FIG. 10 depicts an exemplary Performance Stock Awards (PSUS) GUI implemented within the financial planning system of FIG. 1, according to some embodiments;

FIG. 11 depicts an exemplary Assets GUI implemented within the financial planning system of FIG. 1, according to some embodiments;

FIGS. 12A and 12B depict an exemplary Estate Planning Documents (DOCS) GUI implemented within the financial planning system of FIG. 1, according to some embodiments;

FIGS. 13A to 13D depict an exemplary Case Preparation GUI implemented within the financial planning system of FIG. 1, according to some embodiments;

FIG. 13E depicts the Balance Sheet GUI of FIG. 2A illustrating modifications made to data through use of the Case Preparation GUI of FIGS. 13A to 13D, according to some embodiments;

FIGS. 13F to 13H depict the Case Preparation GUI modifying data, according to some embodiments;

FIG. 13I depicts the Balance Sheet GUI of FIG. 2A illustrating modifications made to data through use of the Case Preparation GUI of FIGS. 13F to 13H, according to some embodiments;

FIGS. 14A and 14B depict an exemplary Debriefers Balance Sheet GUI implemented within the financial planning system of FIG. 1, according to some embodiments;

FIGS. 14C and 14D depict the Balance Sheet GUI of FIG. 2A illustrating modifications made to data through use of the Debriefers Balance Sheet GUI of FIGS. 14A and 14B, according to some embodiments;

FIGS. 15A to 15D depict the Case Preparation GUI adding new data to the financial planning system of FIG. 1, according to some embodiments;

FIG. 15E depicts the Balance Sheet GUI of FIG. 2A illustrating modifications made to data through use of the Case Preparation GUI of FIGS. 15A to 15D, according to some embodiments;

FIGS. 16A and 16B depict the UP GUI of FIGS. 3A and 3B including functionality to save or discard modifications made during a simulation of performance of a client's financial profile, according to some embodiments;

FIGS. 17A to 17C depict the NPV Solution GUI of FIGS. 4A and 4B including another simulation of performance of the client's financial profile, according to some embodiments;

FIGS. 17D to 17G depict the NPV Solution GUI of FIGS. 4A and 4B and the AB GUI of FIG. 5 including another simulation of performance of the client's financial profile, according to some embodiments;

FIG. 18 depicts a Gifting GUI for documenting distributions made from a client's profile, according to some embodiments;

FIG. 19 depicts a Savings Restoration Plan (SRP) GUI for documenting deferred compensation benefits for a client, according to some embodiments;

FIG. 20 depicts a Non-Asset Balance Sheet GUI implemented within the financial planning system of FIG. 1, according to some embodiments;

FIG. 21 depicts a Compensation Deferral Plan (CDP) GUI implemented within the financial planning system of FIG. 1, according to some embodiments; and

FIG. 22 depicts a GUI of a CRM Application including a link to invoke an application of the financial planning system of FIG. 1, according to some embodiments.

In these figures, like structures are assigned like reference numerals but may not be referenced in the description of all figures.

### DESCRIPTION OF PREFERRED EMBODIMENTS

### Introduction

The present disclosure describes novel and non-obvious systems, methods, and computer program products for financial planning that provide relatively simple, streamline, and highly collaborative processes that evaluate a client's financial data, create classes for the client's financial data, and generate financial planning recommendations and a financial plan including calculations defining an allocation of funds between the classes to maintain and/or achieve one or more financial goals of the client. In some embodiments, the collaborative processes are performed in real-time such as, for example, during one or more in-person or remote financial advisor-client meetings. As described herein the systems, methods, and computer program products are implemented in a financial planning system that provides visibility to a client's finances, permits simulation of performance when one or more attributes of the client's financial data (e.g., assets or liabilities) are revised, when needed or desired, calculations performed for rebalancing of a client's funds between the classes of financial data to maintain and/or to achieve one or more financial goals, and provides a measurement tool of performance and/or of the client's decision-making process when considering his/her current and/or anticipated future financial condition. In some embodiments, the measurement tool documents the client's decision-making that may reveal that the client takes a relatively conservative versus a moderate or an aggressive investment strategy. As described herein, the inventive financial planning system employs graphical user interfaces that allow an interactive review, modification, and real-time recalculation of a client's financial data, typically during a face-to-face or remote meeting between the client and one or more of their financial planning advisers.

In some embodiments, the systems, methods, and computer program products described herein are implemented as an integrated, cloud-based financial planning system that displays pertinent data relative to a client's financial assets and allows the client and/or his/her financial planner to make financial decisions including, for example, when the client may plan to retire in a relatively financially comfortable manner and how much the client is able to comfortably spend annually over a period of years during retirement based on the client's current assets, liabilities, risk tolerance (e.g., for assets invested in commercial markets), and a time horizon to retirement. In some embodiments, the systems, methods, and computer program products integrate seamlessly with a customer relationship management software platform such as, for example, SALESFORCE™, and transfers data from the client's household into the financial planning system as described herein. SALESFORCE is a trademark of SALESFORCE, INC. of San Franciso, California USA. In some embodiments, the connection between the customer relationship management software platform and the financial planning system is bi-directional.

In some embodiments, the systems, methods, and computer program products described herein are implemented in a financial planning system that includes a server having a server processor and a server memory operatively coupled to the server processor. The server memory stores server instructions executable by the server processor. The system also includes one or more user devices, operable by one or more users of the system. Each of the one or more user devices has a user device processor, a user device memory operatively coupled to the user device processor, and a user device display operatively coupled to the user device processor. The user device display exhibits a plurality of graphical user interfaces (GUIs) thereon. The one or more user devices communicate with the server over one or more communication networks. Each of the user device memories stores user device instructions executable by the user device processor. In some embodiments, the GUIs of the system include print functionality for the client and/or his/her financial planner or planning administrator to output one or more reports or views of the client's financial data and/or plans for the client's, the financial planner's, or the financial planning institution's recordkeeping purposes (e.g., regulatory or other compliance purposes).

In one aspect of the present disclosure the server processor, when executing the server instructions, is configured to receive financial data of one or more clients, to evaluate the received financial data, to create at least one of one or more classes of assets, one or more classes of liabilities, one or more classes of income, one or more classes of expenses, and to calculate income and spending over a specified period of years to ensure agreed-upon financial plans for the clients maintain or achieve financial goals for each of the one or more clients. The server processor is further configured to store, within the server memory, a client profile for each of the clients. In some embodiments, the client profile includes the created classes of assets, liabilities, income, expenses, and/or financial planning goals for each of the clients of the system. In some embodiments, the server processor is also configured, by executing the server instructions, to generate one or more financial planning recommendations and a financial plan for each of the clients, where the financial planning recommendations and plan may include calculations to generate an allocation of funds between the created classes of assets, liabilities, and/or expenses and store the generated one or more financial planning recommendations and plan in the client profile of each client, to update and/or recalculate values within the stored client profile for the clients upon receipt of at least one new value for the at least one of the created classes of assets, liabilities, income, expenses, and/or financial goals for each client. The server processor may also update the stored client profile for one or more of the clients in response to a request generated by one of the one or more user device processors. The server processor is also configured, by executing the server instructions, to modify the one or more financial planning recommendations and financial plan (e.g., to calculate a rebalance of an allocation of funds between classes) based on the new values to either maintain the created financial goals and/or to achieve new financial goals for each of the client. The server processor is also configured to host the plurality of GUIs for monitoring and updating either the stored client profile and/or the financial planning recommendations and financial plans for clients of the system.

In another aspect of the present disclosure, the user device processor, when executing the user device instructions, is configured to monitor, by invoking one of the plurality of GUIs, the client profile and progress of the one or more financial planning recommendations and financial plan toward the created financial goals and/or the new financial goals for at least one of the clients, to simulate performance of the client profile based on changing at least one attribute/parameter of one of the created classes of assets, liabilities, income, and/or expenses, and based on the simulated performance, to recalculate and to modify the one or more financial planning recommendations and the financial plan with the changed attribute/parameter to either maintain the created financial goals and/or to achieve the new financial goals for the client. The user device processor, when executing the user device instructions, is further configured to generate the request to the server processor to update the stored client profile for the client to include the recalculated and modified financial planning recommendations and financial plan.

### System Overview

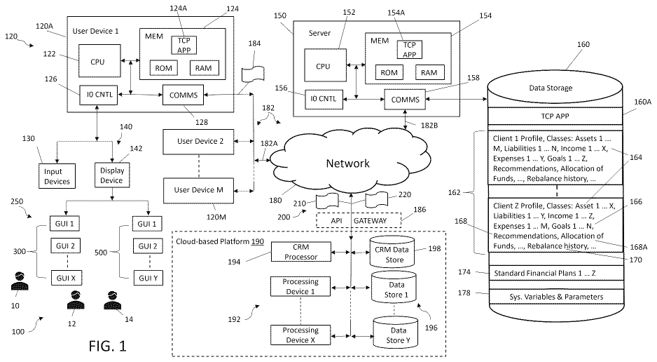

In various embodiments of a financial planning system 100, illustrated in FIG. 1 and referred to as The Collaborative Planner™ system and application, is presented. THE COLLABORATIVE PLANNER is a trademark of Impacting Advisors, LLC of Glastonbury, Connecticut USA. Within The Collaborative Planner system 100 one or more clients, financial planning advisors (hereinafter advisors), and/or financial planning debriefers (hereinafter debriefers) and others, referred to hereinafter as “users” and shown generally at 10, 12, and 14, respectively, operate a plurality of stationary and/or portable communication and/or computing devices (exemplary devices described below) referred to hereinafter as user devices shown generally at 120. The plurality of user devices 120, including user devices 120A (labeled “User Device 1”) to 120M (labeled “User Device M”), are each capable of receiving, processing, and displaying input and output such as financial data, the aforementioned financial planning recommendations, financial plan, system preferences, and the like, and of transmitting the financial data, the financial planning recommendations, the financial plans, messages, or control signals over wired or wireless communication connections shown generally at 182 (e.g., connections 182A) via a network 180 such as, for example, a local area network (LAN), an intranet, extranet, the Internet, or other distributed communication network, to other devices (described below) operatively coupled to the communication network 180. The financial data, the financial planning recommendations, the financial plan, messages, system preferences, and other messages or control signals distributed within the system 100 are illustrated in FIG. 1 generally at 184.

In some embodiments, users of the system 100, e.g., the clients 10, advisors 12, and/or debriefers 14, operating the user devices 120 and/or a server (described below), may be granted differing authorizations or permissions and/or levels thereof, to execute various ones of the features and/or functions of the financial planning system 100 as described herein. For example, the authorizations or permissions may specify whether a user (e.g., client 10, advisor 12, or debriefer 14) may access and/or manipulate, e.g., perform operations upon, data and information stored and/or processed within the system 100 such as, for example, invoking functionality presented on one or more graphical user interfaces described herein. For example, in some embodiments the client 10 may be permitted to only view data and information in the system 100, whereas the advisors 12 and/or debriefers 14 may be permitted to view, update, add, or delete data and information in the system 100. In some embodiments, the users of the system 100 enter login credentials (e.g., username and password, or other information to authenticate or verify the identity of a user), that the system 100 verifies and, once accepted, controls access to the functionality of the system 100.

In one embodiment, each of the user devices 120 includes or is operatively coupled via the network 180 to one or more processors (CPU) 122, memory (e.g., internal memory (MEM) 124 including hard drives, ROM, RAM, and like non-transitory, computer readable storage medium), and/or data storage (e.g., hard drives, optical storage devices, and like non-transitory, computer readable storage medium) as is known in the art. In one embodiment, each of the user devices 120 includes or is operatively coupled to one or more input devices 130 and one or more output devices, shown generally at 140, via an input/output controller (IO CNTL) 126. In one embodiment, the input devices 130 include, for example, a keyboard, mouse, stylus, or like pointing device, buttons, wheels, touch pad, or touch screen portions of a display device, or input ports, and/or combinations thereof, for receiving and providing data and information to the user device 120. In one embodiment, the output devices 140 include, for example, one or more display devices 142 integral with or operatively coupled to the user device 120 to exhibit visual output, a speaker (now shown) to provide audio output, and/or a printer (not shown) to provide printed output. In one embodiment, the visual and printed output includes documents, images, and other visual representations of the data and information within the system 100. In some embodiments, the audio and visual output may include instructional or educational materials such as, for example, audio visual training materials aim to educate users on aspects of their own or other available products within typical user financial portfolios and/or executive compensation packages. In one embodiment, the output devices exhibit one or more graphical user interfaces (GUIs), shown generally at 250, that may be visually perceived by a user/operator operating one of the user devices 120. In some embodiments, the GUIs 250 include a first set of GUIs, e.g., GUI 1 to GUI X shown generally at 300, viewable and operable by authorized clients 10, advisors 12, and debriefers 14, and a second set of GUIs, e.g., GUI 1 to GUI Y shown generally at 500, viewable and operable only by authorized advisors 12 and debriefers 14. In one embodiment, the first set of GUIs 300 are referred to as “Front End” GUIs and the second set of GUIs 500 are referred to as “Back End” GUIs. As described herein, the GUIs 250 are designed to permit interactive review and modification of a client's profile during face-to-face or remote meetings with a financial planning adviser where collaborative financial planning is conducted.

It should also be appreciated that for clarity purposes, components (e.g., CPU, MEM, IO CNTL, input and output devices and the like) are depicted in FIG. 1 only with reference to User Device 1 120A but equally may correspond to one or more of the other user devices 120 (User Device 2 to User Device M). In some embodiments, the user devices 120 include, for example, a personal computer or workstation, or portable computer processing devices such as, for example, a personal digital assistant (PDA), iPAD™ device, tablet, laptop, mobile radio telephone, smartphone (e.g., Apple™ iPhone^{TM} device, Google™ Android™ device, etc.), or the like. It should be appreciated that the designations Apple, iPhone, and iPad are trademarks of Apple Inc. of Cupertino, California. It should also be appreciated that the designations Google and Android are trademarks of Google LLC of Mountain View, California.

In some embodiments, the financial planning system 100 and each of the user devices 120 may be operatively coupled to and/or in communication with, via the network 180, a server 150. In some embodiments, the server 150 includes one or more processors (CPU) 152, memory (e.g., internal memory (MEM) 154 including hard drives, ROM, RAM, and like non-transitory, computer readable storage medium), an input/output controller (IO CNTL) 156 for receiving and outputting data and information via input devices (not shown) and output devices (not shown) coupled thereto, and/or one or more data storage devices 160 (e.g., hard drives, optical storage devices, and like non-transitory, computer readable storage medium) as is known in the art. In one embodiment, illustrated in FIG. 1, each of the user devices 120 and the server 150 include communication circuitry (COMMS) 128 and 158, respectively, such as a transceiver or network interface card (NIC), for operatively coupling the user devices 120 and the server 150 by the wired or wireless communication connections 182 (e.g., connections 182A and 182B) to the network 180, and in some embodiments to a plurality of processing devices 192 including, for example, processing devices 1 to X and/or a plurality of data storage devices 196, for example, data stores 1 to Y, also operatively coupled to and/or communicating with the network 180. In some embodiments, the plurality of processing devices 192 and the plurality of data storage devices 196 provide data and information, shown generally at 200, to the server 150. In some embodiments, communication of data and information passed over the communication connections 182 including, for example, the data and information 200, within the system 100 may be encrypted so that only authorized parties or devices may access, view, and store the data and information.

It should be appreciated that, while not shown, the network 180 may include, for example, cell towers, routers, repeaters, ports, switches, and/or other network components that comprise the Internet and/or a cellular telephone network and/or Public Switched Telephone Network (PSTN), as is known in the art. It should also be appreciated that, in some embodiments, the network 180 may include or utilize, for example, components and/or resources, e.g., the server 150, the processing devices 192, a CRM processor 194 (described below), the data storage devices 196, and a CRM data storage device 198 (described below), operating in a “cloud” or virtual environment, depicted at 190. It should also be appreciated that communication and transfer of data between devices coupled to the network 180 may occur through protocols operating at various Open Systems Interconnection (OSI) model layers including, for example, Transmission Control Protocol/Internet Protocol (TCP/IP) on the Transport and Internet layers and/or the Hypertext Transfer Protocol (HTTP) and interfaces such as, for example, application programming interfaces (APIs), including REST APIs, namely APIs that conform to the design principles of the representational state transfer (REST) architecture, as are known to those skilled in the relevant art.

In some embodiments of the financial planning system 100, the server 150 is connected to the communication network 180 (e.g., via connections 182B) and communicates with the user devices 120 connected with the network 180, for example, sends and receives messages 184 including the financial data, the financial planning recommendations, the financial plans, system preferences, and other messages or control signals. In some embodiments, the plurality of processing devices 192 include a customer/client relationship management (CRM) processor as shown at 194. In some embodiments, the CRM processor 194 communicates with the server 150 directly or when invoked through API calls from the server 150 through an API Gateway 186, to provide client data and/or documents 210, within for example, a client's profile and/or financial portfolio, to the server 150. In some embodiment, the CRM processor 194 is operatively coupled to a CRM data store 198 that stores the client data and/or documents 210. In one embodiment, the CRM processor 194 and the CRM data store 198 are components of a Salesforce™ platform. As noted above, the designation Salesforce is a trademark of Salesforce, Inc. of San Franciso, California.

In some embodiments, a client's financial data may include, but is not limited to, a client's income (e.g., whether received in a paycheck, distribution from the client's business, or other sources), a client's liabilities, a client's expenses, information within a state or federal tax return, financial statements for client accounts at banks or other financial institutions including bank account statements, investment account statements, insurance policies (with and without a cash redemption value), retirement account statements (e.g., from a pension, 401(k), IRA, or Roth IRA accounts, or the like), mutual funds, stocks, bonds, annuities and any other assets. In some embodiments, one or more of the client's assets such as, for example, mutual funds, stocks, bonds, or other publicly or market-traded securities or commodities, may be held in a financial investment account (referred to hereinafter as a client's portfolio) held in a third-party system, whose value is monitored and tracked by the financial planning system 100. Assets may also include, for example, equity grants within employment compensation including stock appreciation rights (SARs), restricted stock units (RSUs), performance stock units (PSUs), as well as real property assets such as residential homes, vacation homes, investment property, and the like. Some assets may also have an associated liability such as, for example, a mortgage or loan secured by the asset. The financial data may include expenses and liabilities such as, for example, regular payments toward credit card debt, student loans for the client or one or more of their dependents, mortgages on real property, and the like. In some embodiments, the financial data within the financial planning system 100 may include anticipated income and/or expenses, anticipated large expenditures such as, for example, educational expenses for one or more dependents, home ownership expenses for the client or one or more of their dependents, travel expenditures, and the like. In some embodiments, the client's financial data may include information related to their retirement such as, for example, a planned retirement start date, preferred retirement income distribution strategy with projected expenses, for example. As noted above, the client's financial data is stored within the financial planning system 100 within a profile established for the client.

In one embodiment, the client's profile may also include, but is not limited to, age of the client, marital status of the client, gender of the client, and the age and gender of the client's spouse, dependents, and beneficiaries. As noted above, the client's profile includes details relating to the client's assets and liabilities. In some embodiments, the client's profile may also include information relating to one or more of the client's financial goals (e.g., short-, medium-, or long-term goals) and their priority in terms of dollar value and/or timing, anticipated rates of inflation assuming various strategies for conservative or aggressive savings, expenditures, investment, and/or market risk. In some embodiments, and as discussed in detail below, the financial planning system 100 allows clients 10, advisors 12, and debriefers 14, to periodically review and, as necessary or desired, revise one or more financial goals and/or set new financial goals for the client. In some embodiments, a financial goal may be comprised of, for example, a financial position goal (e.g., achieving stability or liquidity by paying off a debt, building an emergency fund, or the like), a retirement goal, an education goal, a major purchase goal, a cash reserve goal, an income tax goal, an investment planning goal, an employee benefits planning goal, a survivor income goal, a disability income goal, a long term care planning goal, a healthcare planning goal, a property and casualty planning goal, an estate planning goal, a divorce planning goal, a financial planning goal of a business owner, or any combination of the foregoing.

Referring again to FIG. 1, in some embodiments, third-party financial information is provided to the financial planning system 100 to notify the system of changes in values of one or more of the assets, liabilities, and/or other financial data held by one or more clients of the financial planning system 100. For example, the financial planning system 100 may receive, within a notification message 220, new market values for assets, including stocks, bonds, etc., held within client profiles and the portfolio of one or more of the clients 10 registered as users of the system 100. In some embodiments, the notification message 220 may be received by, for example, an electronic mail messages from clients, brokers, and/or advisors, electronic broadcast messages, alerts, or like dissemination of news and/or information from, for example, financial markets, API calls, or data feeds (e.g., XML feed, CSV feed, or like data feeds) from one of the processing devices 192 to the server 150. In some embodiments, new market values are received at or after the close of a business day for market-traded securities and/or commodities. In one embodiment, one of the clients 10 communicates an action taken on one of their assets, for example, the exercise (e.g., sale) of a stock or stock option within the profile/portfolio, to the financial planning system 100 by operating one of the user devices 120 to directly input the change in their portfolio, provided as the aforementioned financial data 184, to the server 150. In one embodiment, the notifier operates one of the user devices 120 to input the financial data 184 via, for example, one of the GUIs 250 (described below), which then generates and sends the financial data 184 to the server 150.

In one aspect of the financial planning system 100, the user devices 120 and the server 150 execute a plurality of programmable instructions of a multifunctional financial planning software application or app, e.g., The Collaborative Planner software application or app (labeled “TCP APP”), portions or modules thereof, 124A, 154A, or 160A, stored in local memory 124 of the client devices 120 and local memory 154 of the server 150, or network memory 160, respectively, to implement the system 100 and features and/or functions thereof. As described herein the TCP APP 124A, 154A, or 160A receives financial data, e.g., included within messages 184 and/or provided through operation of one of the GUIs 250, evaluates a client's financial data, and creates classes for the financial data including, for example, one or more classes of assets, liabilities, income, and/or expenses. As shown in FIG. 1, in some embodiments, the TCP APP 124A, 154A, 160A stores the created classes within one or more client profiles, shown generally at 162, of the storage device 160. For example, the client profiles 162 include a profile for one or more clients 10, including a Client 1 Profile to a Client Z Profile, and Classes 164 of one or more assets, one or more liabilities, one or more income, and/or one or more expenses of each respective client 10. The client profiles 162 may also include one or more financial planning goals 166 of each respective client. In some embodiments, the advisors 12 and debriefers 14 may work with the client 10 and leverage the TCP App 124A, 154A or 160A to calculate the client's income and spending over a period of years under generated financial planning recommendations and plans 168 which are stored within the client's profile 162. The financial planning recommendations and plans 168 may include calculations of an allocation of funds 168A between the classes 164 of assets, liabilities, income, and/or expenses of each respective client 10 to maintain and/or achieve one or more financial planning goals 166 of the client 10. In some embodiments, the client profiles 162 may include a history of reallocations of funds across the Classes 164 of one or more assets, one or more liabilities, one or more income, and/or one or more expenses of each respective client 10, as the profile is revised to reflect changing financial conditions, referred to herein as a rebalance process and related Rebalance History 170. In some embodiments, the data storage device 160 or network memory, may store one or more standard and/or default financial plans 174 that may be useful as a starting point for various types of clients, and other variables and/or parameters 178 of the system 100 that are used by the system.

As noted above, the financial planning system 100 receives financial data 184 and notification messages 220 that may indicate changes in a value of one or more of the assets, liabilities, and/or other financial data within one or more of the client profiles 162. Depending upon actions taken by a client (e.g., a sale of an asset) and/or a market trend, values within the classes 164 may increase or decrease and therefore impact one or more clients'short-, medium-, or long-term financial goals (e.g., the financial goals 166). For example, revised financial data 184 may be provided to the server 150 by one or more of the clients 10, advisors 12, or debriefers 14 operating one of the GUIs 250 or the third-party financial information may be provided to the server 150 via the notification message 220 generated at a close of financial markets and, in some embodiments, automatically transmitted to the system 100. In response to the receipt of one of more new values for one of the created classes 164 of assets, liabilities, income, expenses, and/or the financial planning goals 166, the server 150 recalculates income and spending and updates the stored client profile 162 for one or more of the clients to reflect the new values. In some cases, the new values and recalculations based thereon, may also trigger a need or desire to revisit and possibly adjust one or more financial planning recommendations and plans 168 to remain on target to maintain and/or to achieve a current or a new financial goal 166 for one or more of the clients 10. If the client 10 and/or their advisor 12 deem a review of the client's profile appropriate, the client 10, the advisor 12, and/or the debriefer 14 may exercise one or more of the GUIs 250 (described in more detail below) to perform such a review, typically in an interactive, face-to-face or remote (e.g., video) meeting.

In some embodiments, the TCP APP 124A executing on one of the client devices 120 cooperates with the TCP APP 154A executing on the server 150 to receive and to exhibit one or more of the GUIs 250 on the display device 142 of the client device 120. In this manner, the server 150 hosts the GUIs 250 and presentation thereof on the client devices 120, receives input therefrom, and exhibits output thereon. As described above and in further detail below, in some embodiments, the GUIs 250 include the first set of GUIs 300, e.g., the Front End GUIs, viewable and operable by authorized clients 10, advisors 12, and debriefers 14, and the second set of GUIs 500, e.g., the Back End GUIs, viewable and operable only by authorized advisors 12 and debriefers 14. As described herein, the GUIs 250 are designed to permit interactive review and modification of a client's profile during face-to-face or remote meetings between the client 10 and at least one of the advisers 12 and/or debriefers 14.

In some embodiments, the Front End GUIs 300 may be utilized by the clients 10 to review and monitor their client profile 162 and/or progress being made by adopting one or more financial planning recommendations and plans 168 toward achieving one or more financial goals 166 of the client. In some embodiments, one or more of the Front End GUIs 300 and Back End GUIs 500 may be operated by advisors 12 or debriefers 14 to update values of one or more of the classes 164 of assets, liabilities, income, expenses, and/or the financial goals 166 within a client profile 162. Once updated, the advisor 12 or debriefer 14 may initiate a request for the server 150 to recalculate the client's income and spending over a period of years and to update the stored client profile 162 to reflect the updated values. In some embodiments, the one or more of the Front End GUIs 300 and Back End GUIs 500 may be operated by advisors 12 or debriefers 14 to simulate performance of the client profile 162 based on changing at least one attribute of at least one of the created classes 164 of assets, liabilities, income, and/or expenses. Based on the simulated performance, one or more of the Front End GUIs 300 and Back End GUIs 500 may be operated by advisors 12 or debriefers 14 to recalculate the client's income and spending over a period of years and to modify one or more of the financial planning recommendations and plans 168 with the changed attribute to maintain one of the client's current financial goals 166 and/or to achieve a new financial goal 166. In some embodiments, once one or more of the financial planning recommendations and plans are modified and income and spending recalculated, the utilized one of the GUIs 300 and 500 may generate a request to the server 150 to update the stored client profile 162 to include the modified recommendations and plans 168. In some embodiments, the changed attribute of one of the created classes 164 of assets, liabilities, income, and/or expenses may include at least one of changing a value of one or more of the assets, liabilities, income, and/or expenses, removing one of the assets, liabilities, income, and/or expenses from the client profile 162, or adding a new asset, liability, source of income, and/or expense to the client profile 162.

### Front End GUIs

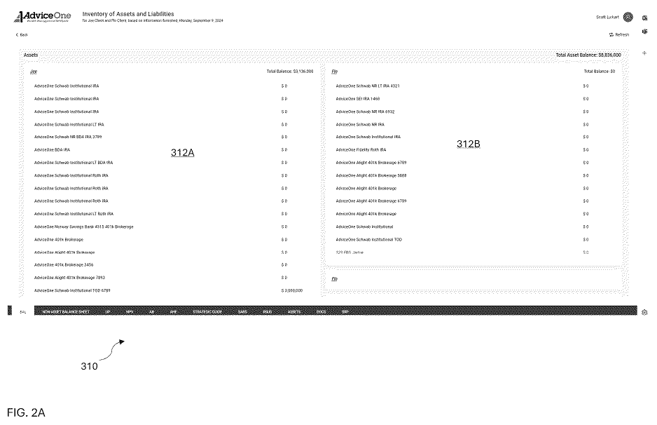

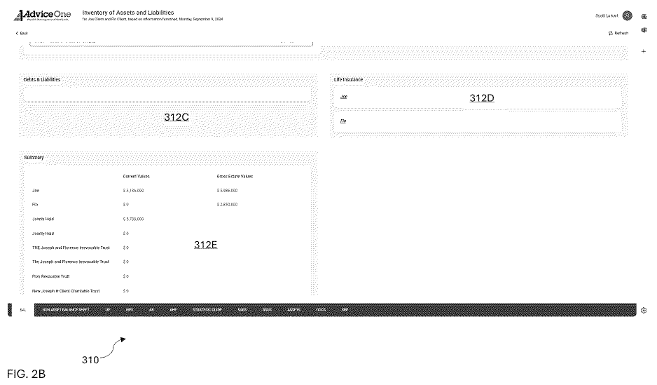

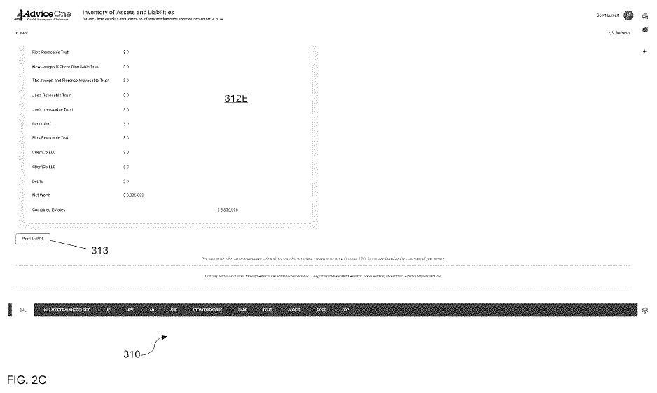

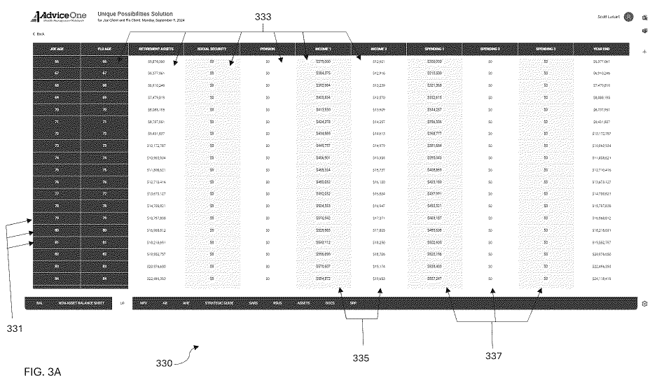

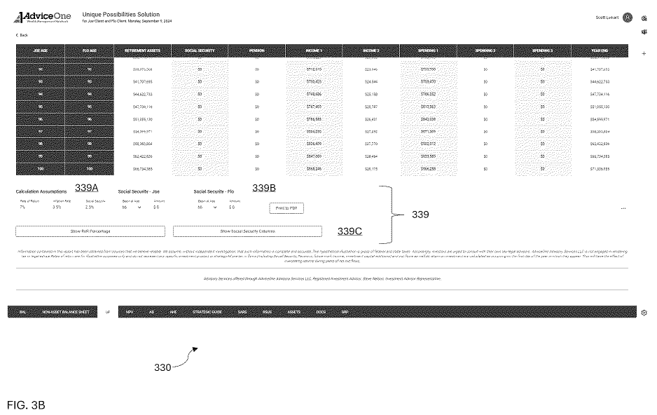

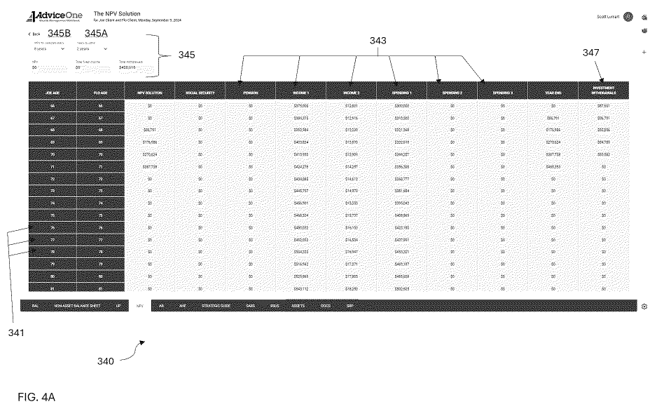

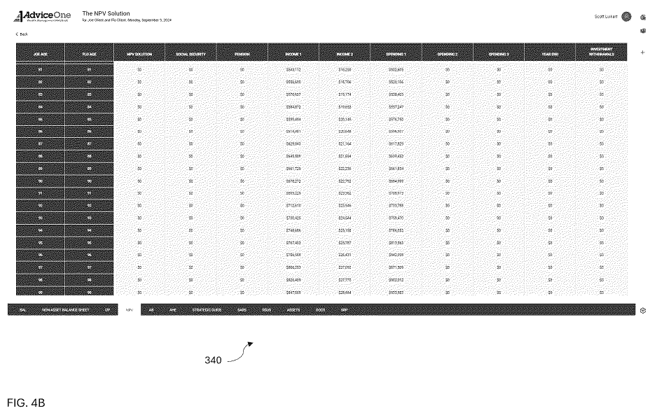

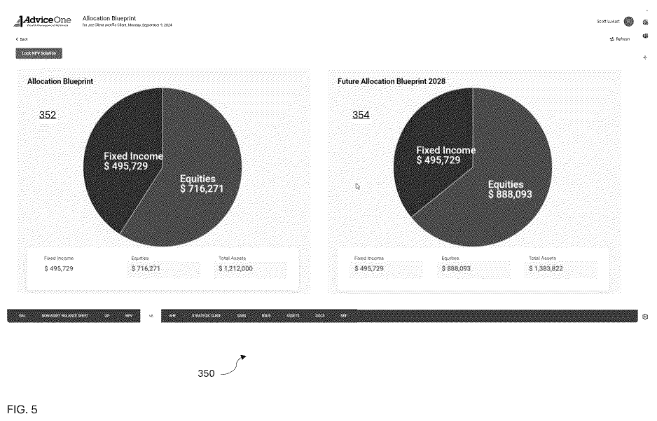

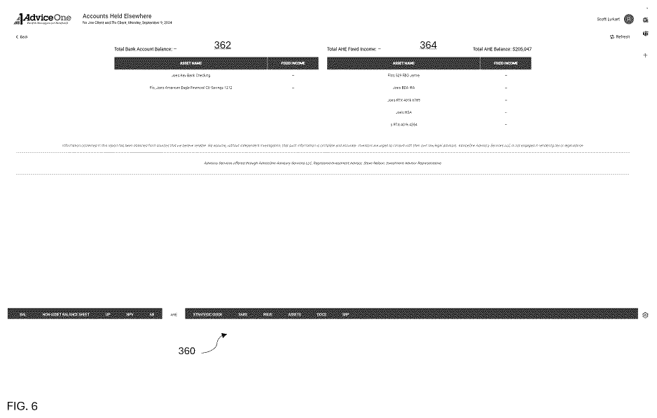

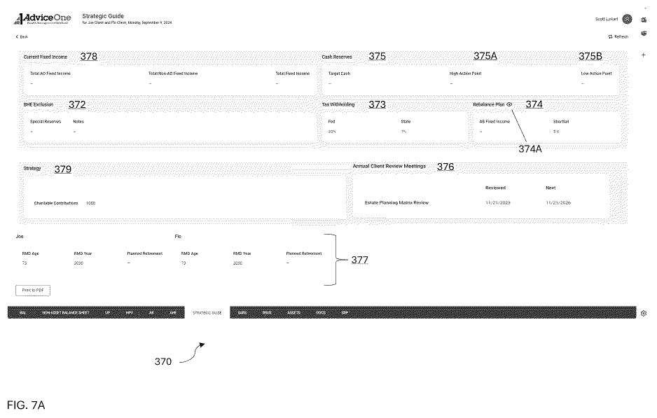

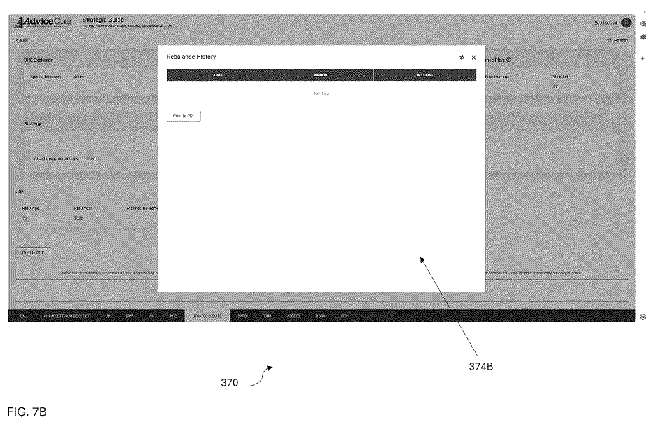

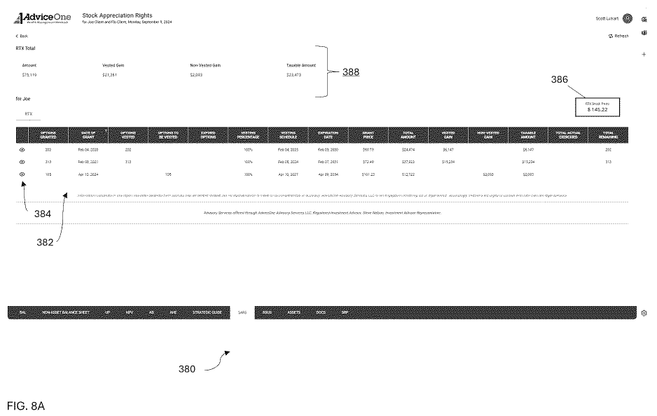

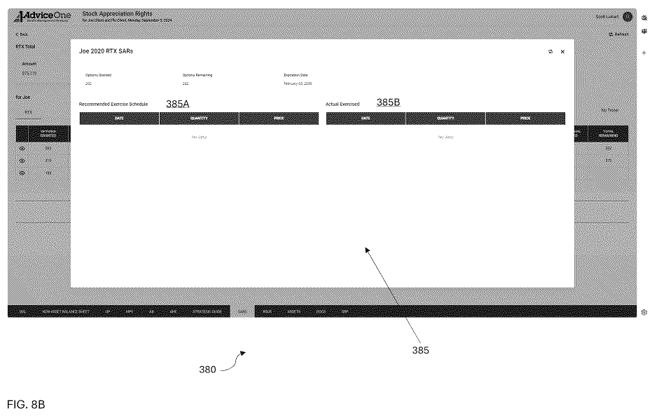

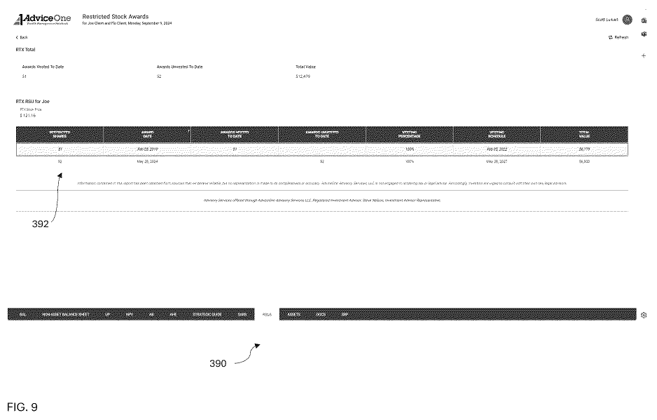

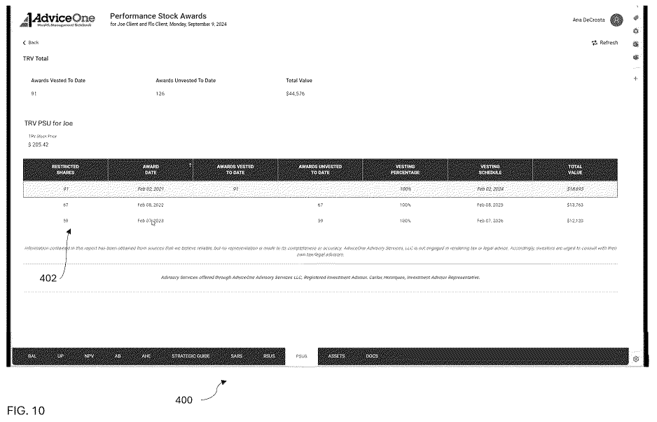

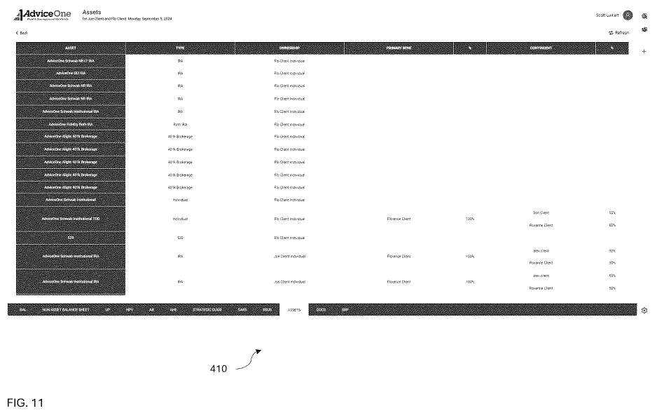

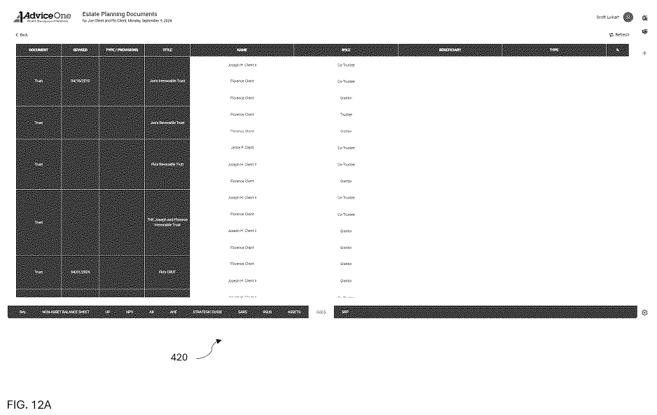

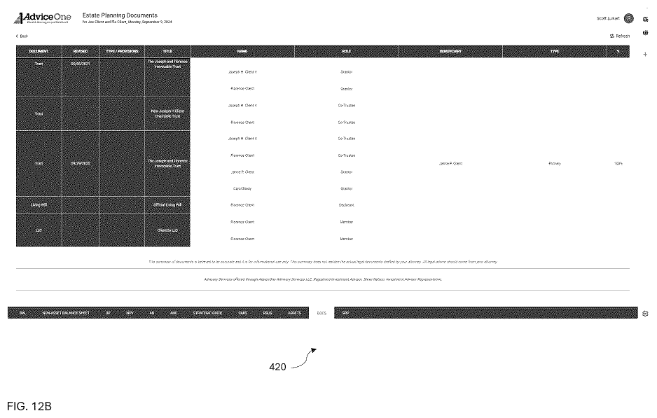

In some embodiments, the Front End GUIs 300 include a Balance Sheet (BAL) GUI 310 as depicted on FIGS. 2A to 2C, a Unique Possibilities Solution (UP) GUI 330 as depicted on FIGS. 3A and 3B, a Net Present Value (NPV) Solution GUI 340 as depicted on FIGS. 4A and 4B, an Allocation Blueprint (AB) GUI 350 as depicted on FIG. 5, an Accounts Held Elsewhere (AHE) GUI 360 as depicted on FIG. 6, a Strategic Guide GUI 370 as depicted on FIGS. 7A and 7B, a Stock Appreciation Rights (SARS) GUI 380 as depicted on FIGS. 8A and 8B, a Restricted Stock Awards (RSUS) GUI 390 as depicted on FIG. 9, a Performance Stock Awards (PSUS) GUI 400 as depicted on FIG. 10, an Assets GUI 410 as depicted on FIG. 11, and an Estate Planning Documents (DOCS) GUI 420 as depicted on FIGS. 12A and 12B.

As shown in FIGS. 2A to 2C, in some embodiments, the BAL GUI 310 exhibits an inventory or list of a client's assets and liabilities within the one or more classes 164 created by the TCP APP 124A executing on one of the client devices 120 or the TCP APP 154A, 160A executing on the server 150 from the client's received financial data 184. In some embodiments, the inventory or list reflects assets and liabilities for two or more related clients, e.g., spouses or partners within a common household (referred to hereinafter as a “client-household”), that have consolidated their financial planning needs such that specific financial planning advice may be tailored to the clients'individual and/or joint/client-household financial planning needs. In one embodiment, the classes 164 may be listed by account type including, for example, trust accounts, Individual Retirement Accounts (IRAs), Roth IRAs, non-qualified accounts, bonds, life insurance, and the like, as well as liabilities including, for example, mortgages, loans, and other debts. In some embodiments, the lists of assets and liabilities may include irrevocable assets, that may be presented on a different, additional balance sheet as the irrevocable assets are not part of a client's gross taxable estate. In some embodiments, the type of assets and liabilities exhibited on the BAL GUI 310 depict a total net worth and gross estate values for the client and/or the client-household. In some embodiments, viewing assets and liabilities individually and in a client-household manner allows for financial planning that may account for certain aspects of estate planning such as, for example, providing visibility to assets with and without survivorship provisions that may define and/or control disposition of one or more assets at a death or an incapacity of the client and/or a member of the client-household. In some circumstances, such proactive financial planning may minimize or eliminate a need to involve a probate court to oversee disposition of the one or more assets at death or incapacity. In some embodiments, the BAL GUI 310 depicts net worth and gross estate values identifiable by client ownership (e.g., Joe Client's assets and liabilities) and/or by the client-household ownership (e.g., Joe Client's and Flo Client's combined assets and liabilities) thus exhibiting a client's individual and/or combined ownership and gross net asset values and net worth. For example, FIG. 2A exhibits assets 312A and 312B of a married financial planning couple (e.g., client-household) Joe Client and Flo Client, respectively, with a current value for each asset exhibited. FIG. 2B exhibits debts and liabilities 312C of Joe Client and Flo Client, if any, Life Insurance assets 312D of Joe Client and Flo Client, if any, and provides a summary view 312E (at FIGS. 2B and 2C) individually and jointly, also with current values exhibited. As described above and illustrated in FIG. 2C at 313 on the BAL GUI 310, one or more of the Front End GUIs may include print functionality for the client and/or their financial planner or planning administrator to output a report or view of the client's financial data as presented on the corresponding one of the GUIs for the client's, the financial planner's, or the financial planning institution's recordkeeping purposes (e.g., regulatory or other compliance purposes).

As shown in FIGS. 3A and 3B, the UP GUI 330 exhibits aspects of a client's financial data 184 stored within the client profile 162 in a “row,” shown generally at 331, and “column,” shown generally at 333, presentation where the advisor 12 can present and the TCP APP 124A, 154A, 160A can calculate the client's income (e.g., earnings from employment and gains in value of assets) and spending (e.g., expenditures and loss in value of assets) in an integrated format calculated over a period of years and perform scenario modeling, for example, changing a client's income and/or spending, to demonstrate an impact of the changes on the client's assets. For example, in some embodiments, the UP GUI 330 presents the client's calculated income in income columns, shown generally at 335 and labeled “Income 1” and “Income 2”, versus the client's actual or planned spending, in spending columns shown generally at 337 and labeled “Spending 1” “Spending 2” and “Spending 3”, for a range of years, e.g., until the client reaches at least an age of, for example, one hundred (100) years old. While exhibited in the row and column presentation, the UP GUI 330 provides the client's financial data 184 from the client's profile 162 stored within data storage device 160 and calculations based thereon, and, as such, reflects an integrated, interactive, real-time value of the client's financial data. For example, changes made on the BAL GUI 310 of FIGS. 2A to 2C are immediately exhibited on the UP GUI 330 of FIGS. 3A and 3B. Additionally, in some embodiments, the TCP App 124A, 154A or 160A of the financial planning system 100 receives, via one or more of the notification messages 220, updated current market values of the client's assets and/or liabilities, and the updated values are immediately reflected in calculations exhibited on the BAL GUI 310 and the UP GUI 330. As should be appreciated, the advisor 12 led scenario modeling of assets versus spending allows the client 10 to see if they are on a relatively “good” curve (e.g., a “green” curve, where spending does not adversely impact accumulated asset) as compared to a relatively “troubled” curve (e.g., a “red” curve, where spending is significantly depleting accumulated assets). While spending is described in terms of one or more “curves,” a visual depiction may not be exhibited on one or more of the Front End GUIs 300. Rather, it should be appreciated that the use of the “curve” terminology merely connotes tracking financial expenditures/spending against a planned or modeled budget over a period of time within a client's financial plan. As such, the UP GUI 330 provides real-time visibility, through calculations made by the TCP APP 124A, 154A, and 160A, to the impact of the client's investment and retirement decisions such as, for example, when the client starts receiving earned social security benefits, pension benefits and options pertaining thereto, and like income (e.g., starting at age 62 versus age 70), what may occur if a client passes away while receiving such benefits, what if the client decides to purchase a vacation home at varying costs (e.g., $350,000 versus $500,000, in cash versus with a mortgage), what may occur if the client's sell one property to “downsize” to a smaller property, and how those selections may impact calculated income and spending during retirement to demonstrate in real-time when the client can “afford” to retire in a financial comfortable manner by adhering to an agreed upon plan determined by the client 10 and advisor 12 using the financial planning system 100. In some embodiments, for example where the client 10 is on a good or green curve, the advisor 12 can add spending, for example, in a third of the spending columns 337 labeled “Spending 3” to do, for example, depict “what ifs” scenarios based on one or more years of hypothetical spending and calculations based thereon. For example, if the client 10 were to retire at age sixty-five (65), the client 10 with a good curve can spend an extra amount of money (e.g., $30,000) each year from age sixty-five (65) to seventy-five (75) and would still maintain assets to an age of one hundred (100) years old. Alternatively, where the client 10 is on a troubled or red curve, the advisor 12 and client 10 can selectively adjust spending such that when the client 10 retires, their spending can be reconsidered/recalculated as the client 10 may use supplemental income acquired from, for example, their social security benefit or a pension. It should be appreciated that some advantages of the advisor 12 led scenario modeling performed with the UP GUI 330 include an ability to conduct collaborative interactions between the client(s) 10 and the advisor 12, where multiple adjustments, for example, in income (e.g., income earned through continued fulltime work or selecting a level of the client's pension or social security benefit), spending, a planned time to retirement (e.g., one or more years of full-time work prior to a planned date of retirement), and real-time recalculation based thereon, can be demonstrated with, for example, benefits and disadvantages of the adjustments discussed in real-time, such that as one or more adjustments are actually implemented with the client's financial planning, the client involvement in the decisions made during the advisor 12 led scenario modeling performed with the UP GUI 330 may create “client ownership” of the resulting financial plan.

In some embodiments, the UP GUI 330 is reviewed after a previous advisor led scenario modeling is performed and may be used, for example, to make further adjustments in a next scenario modeling meeting, based upon the client's current progress toward implementing the previous financial plan. In some embodiments, as illustrated in FIG. 3B, the UP GUI 330 includes functionality 339 for making other adjustments to the income versus spending depicted in the UP GUI 330. For example, the functionality 339 of the UP GUI 330 may include functionality, shown generally at 339A and labeled “Calculation Assumptions,” for selectively adjusting how calculations are performed for accumulating a value of assets (e.g., a Rate of Return (RoR) exhibited at “7%”, Inflation Rate exhibit at “3.5%”, and/or an anticipated increase in a benefit such as Social Security exhibited as “2.5%”). In some embodiments, the TCP App 124A, 154A or 160A of the financial planning system 100 may set default values for the functionality 339 (e.g., setting long-term, possibly conservative or moderate financial market assumptions), which may be adjusted by the advisor 12 and client 10 based on, for example, a client's risk tolerance. In some embodiments, the functionality 339 may be used to account for temporary sharp increases or decreases in market conditions and periods of adjustments or rebounds therefrom. The functionality 339 may also include functionality, shown generally at 339B and labeled “Social Security—Joe” (e.g., a first person of a client-household) and “Social Security—Flo” (e.g., a second person of the client-household) to permit exhibiting combined and/or individual assumption values. As shown in FIG. 3B, the functionality 339B may include an age to begin and a monetary amount of social security income taken by a client. In one embodiment, the age may include a dropdown menu for selecting age from a range of available values. In some embodiments, the adjustments to the assumptions 339A, 339B may be based on, for example, a client's risk tolerance. In some embodiments, the functionality 339 includes options, implemented via control button shown generally at 339C and labeled “Show RoR Percentage” and “Show Social Security Columns”, to exhibit current values of the adjustments to the assumptions 339A, 339B (e.g., income from social security) within the row 331 and column 333 presentation (FIG. 3A). As should be appreciated, perceived advantages of the UP GUI 330 include, for example, a highly customizable presentation and calculation to aid understanding of the client's financial situation, currently and in the future (over the exhibited period of years), a platform for allowing better, more informed decision-making on major financial issues including, for example, the decision of “when can I afford to retire,” “which option do I take with my earned Social Security benefit and/or with my pension,” “to enjoy a preferred level of spending, should I get a job or perform consulting in my retirement years,” and the like, to maintain and/or achieve desired levels of income and spending.

As shown in FIGS. 4A and 4B, the NPV Solution GUI 340 also exhibits aspects of a client's financial data 184 stored within the client profile 162 in a “row,” shown generally at 341, and “column,” shown generally at 343, presentation where the advisor 12 can demonstrate variations in the client's assets and spending and calculations based thereon. In some embodiments, the advisor 12 demonstrates how a client's assets are included in, for example, fixed income versus equity (e.g., value being accumulated within shares of stock or other investments in the market) within the client's total financial portfolio. In some embodiments, the advisor 12 may leverage the NPV Solution GUI 340 to demonstrate a recommendation and financial plan to maintain a calculated allocation of fixed income to meet and/or provide for a client's planned spending within a specified period of years such as, for example, eight (8) to ten (10) years. For example, the advisor 12 may consider and have the TCP App 124A, 154A or 160A solve for (e.g., perform real-time calculations), and demonstrate to the client 10, a recommendation and plan of how existing assets including, in some embodiments, benefits and/or income received from a pension and/or social security, may be utilized to meet the client's current and/or planned spending over the specified period. The recommendation and financial plan from the advisor 12 may include a calculation and an exhibition on the NPV Solution GUI 340 depicting what withdrawals from the client's investments, shown generally at 347, would be needed to meet the client's current and/or planned spending goal or goals over the specified period. As should be appreciated, the recommendation and financial plan from the advisor 12 may demonstrate how funds can remain, for example, in equities and continue to “grow” (e.g., accumulate in value) based on market performance, while balancing funds to meet a desired period of spending, for example, an at least eight (8) years of funds maintained in, for example, a lower risk portfolio that the advisor 12 has selected to account for any stock market volatility. With the NPV Solution GUI 340, the advisor 12 and the client 10 can visualize calculations of income and spending and decide, for example, how much money, for example, for what period of time (e.g., one or more years), the client 10 wants to keep in cash, as fixed income outside the stock market, and/or another less liquid investment.

In some embodiments, when the client 10 is not yet retired, the advisor 12 may employ the NPV Solution GUI 340 to demonstrate (e.g., calculate) how future withdrawals, for example, withdrawals taken to fund retirement spending at a future date when the client 10 has actually retired, may affect the client's total financial portfolio. As shown in FIG. 4A, the NPV Solution GUI 340 includes functionality, shown generally at 345, where the advisor 12 and client 10 may specify a target year for retirement, for example, defining a decision that the client 10 wants to retire in a predetermined number of years, e.g., “2 years” as shown generally at 345A and labeled “Years to retire,” and have spending for post-retirement set at a second predetermined number of years, e.g., “8 years” as shown generally at 345B and labeled “NPV for selected years.” The financial planning system 100 then calculates and exhibits, in the NPV Solution GUI 340, the funds that must be set aside to accommodate the spending for the defined set of years. As should be appreciated, the NPV GUI 340 is selectively customizable, via the functionality 345, based on individual client financial needs and goals.

As shown in FIG. 5, the AB GUI 350 exhibits a calculated allocation blueprint, as defined with the planning system 100, depicting a split in or assignment of assets between categories including, in some embodiments, fixed income and equity, for example, at a present time, shown generally at 352 and labeled “Allocation Blueprint”, and at a future time of retirement such as, for example, in a year “2028” as shown generally at 354 and labeled “Future Allocation Blueprint 2028.” If the values within the allocation scenarios are different (e.g., current as compared to future), then the AB GUI 350 exhibits to the advisor 12 and the client 10 a calculation of how much funds need to be moved from equity at present to fixed income during retirement to support spending. For example, if fixed income is a value of five hundred thousand dollars ($500,000.00) but in retirement the client 10 needs income of six hundred thousand dollars ($600,000.00) to support spending and the client 10 plans to retire in four (4) years, then a plan for the client 10 over the next four (4) years is to, for example, transfer a difference of one hundred thousand dollars ($100,000.00) over, for example, equal twenty-five thousand dollars ($25,000.00) per year transfers from equity to fixed income. As should be appreciated, the client 10 and advisor 12 may agreed upon and record other types of transfers, for example, not necessarily equal yearly transfers, as the UP GUI 330 (FIGS. 3A and 3B), the NPV Solution GUI 340 (FIGS. 4A and 4B), and AB GUI 350 (FIG. 5), can accommodate and depict uneven yearly transfers to support the client's financial needs and goals. As should also be appreciated, the AB GUI 350 is based on the agreed upon planned assets and spending, and calculations based thereon, as defined by the advisor 12 and the client 10 using the UP GUI 330, which may be adjusted and exhibited in the AB GUI 350 in real-time based on changes made to the plan in the UP GUI 330. In some embodiments, the AB GUI 350 includes functionality to invoke calculators defining an agreed upon plan for how to move from a current asset allocation to a future asset allocation over a defined period of time to support the client's financial needs and goals.

As shown in FIG. 6, the AHE GUI 360 exhibits total assets of a client 10 (e.g., individual or client-household) that are held at other financial institutions outside the financial planning system 100 (e.g., bank accounts as shown generally at 362 and company sponsored accounts, e.g., accounts held by the client's company or employer such as 401k accounts, FBO accounts (an account held For the Benefit of Another), BDA account (a Beneficiary Distribution Account), a HSA account (Health Saving Account) and the like, as shown generally at 364), and identifies whether the assets are fixed income (e.g., investment securities that pay investors fixed interest or dividend payments until maturity such as, for example, government or corporate bonds), equity (e.g., common stock, preferred stock, share capital, etc.) or cash (e.g., cash in conventional bank accounts and/or short term investment accounts such as, for example, certificate of deposit (CD) accounts, Treasury bill (T-bill), etc.). The AHE GUI 360 allows the client 10 and advisor 12 to view and understand an entire picture of the client's financial assets both within the financial planning system 100 and held outside the system 100 and is utilized in, for example, calculating the client's allocation blueprint (e.g., presented on the AB GUI 350 (FIG. 5)) as well as the balance sheet (e.g., presented as assets on the BAL GUI 310 (FIGS. 2A to 2C)).

The Strategic Guide GUI 370 (FIGS. 7A and 7B) provides the advisor 12 and client 10 a mechanism for entering and exhibiting a summary of major assumptions and/or nuances in implementing the client's financial plan. The Strategic Guide GUI 370 provides a consolidated view that the clients 10 and the advisor 12 may refer to as a guide documenting and illustrating agreed-upon actions taken or to be taken, for example, decisions made during one or more collaborative financial planning meetings, in implementing the client's financial plan and a rebalance plan to accommodate modifications to a previous financial plan to meet the client's financial planning goals in a new financial plan. The Strategic guide GUI 370 may also provide a summary view of items discussed at previous and/or to be discuss at a next financial planning meeting between the client 10 and the advisor 12 including in some cases, for example, requests to the client to perform actions and/or gather additional information (e.g., client “homework”). As noted above, in some embodiments, the Strategic Guide GUI 370 may include print functionality for the client and/or their financial planner or planning administrator to output a report or view of the guide documenting agreed upon actions taken or planned to be taken, decisions, client research or investigation of various financial planning options, and the like, in implementing the client's financial plan. In some embodiments, assumptions may include, for example:
BHE (Bonds Held Elsewhere) Exclusions, shown generally at 372, where, for example, cash may be earmarked, reserved, and/or otherwise set aside for a future large expense, such as for example, a down payment on a house or other real property, a wedding, educational expenses, etc.).
Tax withholding assumptions, shown generally at 373, where, for example, the advisor 12 and client 10 can document targeted percentages for federal and/or state withholding from income and make adjustments for real-time tax planning. In some embodiments, the tax withholding assumptions represent an actual amount of tax withheld for all client accounts within the system 100 at, for example, a clearing firm or custodian, to depict the withdrawal due to annual tax liability of the client and/or client-household.
Rebalance Plan, shown generally at 374, where the system 100 illustrates whether the client 10 is in a shortfall in their allocation blueprint (e.g., funds allocated in fixed income versus equity) and by how much, if any. The Rebalance Plan 374 informs the advisor 12 what (e.g., how much) to sell in equity to have cash in reserve during an allocation rebalance to align the client's allocation blueprint. In some embodiments, selecting a Rebalance Plan control button 374A invokes a Rebalance History dialog box, shown generally at 374B at FIG. 7B, exhibiting a history of previous rebalances to the Allocation Blueprint of the client's financial plan, if any. While not depicted with actual data/values on FIG. 7B, it should be appreciated that the Rebalance History dialog box 374B may also include a designated equity account (e.g., an IRA account) and/or one or more accounts, where funds may be withdrawn to replenish the client's fixed income accounts (e.g., cash assets), and/or an order in which funds should be withdrawn when two or more accounts are identified as sources for replenishment/rebalancing. In some embodiments, a cap, maximum, or other limit may be placed upon an amount of a withdrawal such that, for example, a full value of an identified source account may not be liquidated during replenishment/rebalancing, if so specified by the client.
Target cash, shown generally at 375 in a Section labeled “Cash Reserves,” and also including a “High Action Point” definition, shown generally at 375A, and a “Low Action Point” definition, shown generally at 375B, illustrates whether the client 10 has a shortfall or an excess to their allocation of cash assets. As should be appreciated, an excess of cash assets means assets may not be accumulating at a rate that may be achieved at a higher earning percentage in the market as compared to, for example, an equity asset. If an excess (e.g., exceed the “High Action Point” 375A) or a deficit (e.g., at or below the “Low Action Point”375B) is exhibited, the client 10 and the advisor 12 can discuss adjustments to the financial plan to achieve the level of funds included at the Target Cash 375 definition. In some embodiments, the Strategic Guide GUI 370 may also include a definition of a “Special Reserve” (not shown) where an amount of cash funds may be allocated for an identified special occasion or event such as, for example, a wedding for the client or one or more dependents of the client, or a home improvement or renovation.
Review of client meetings and types, shown generally at 376 and labeled “Annual Client Review Meetings,” where for example, the advisor 12 documents milestones of a periodic review (e.g., at least annual review) of the client's financial plan including an investment review, a UP review (e.g., contents of the UP GUI 330 (FIGS. 3A and 3B), a NPV review (e.g., contents of the NPV Solution GUI 340 (FIGS. 4A and 4B), a AB review (e.g., contents of the AB GUI 350 (FIG. 5), and, in some embodiments, an estate planning review, discussed below.
Discussion of required minimum distribution (RMD), shown generally at 377, where the advisor 12 and the client 10 review the minimum amount of money that must be withdrawn annually from the client's retirement accounts to comply with federal tax rules for each client in a client-household, and in some embodiments, how the withdrawal is utilized in the client's allocation blueprint.
Shows fixed income data, shown generally at 378 and labeled “Current Fixed Income,” within accounts managed in the system 100 and at accounts held away (e.g., AHE), corresponding to data exhibited on the BAL GUI 310 (FIGS. 2A to 2C).
Strategies, shown generally at 379 and labeled “Strategy,” for distribution under the client's financial plan. Documenting and exhibiting these strategies ensures that client 10 and advisor 12 understand and agree to the overall strategy of the client's financial plan.

As shown in FIGS. 8A and 8B, the SARS GUI 380 exhibits additional executive benefits beyond salary (e.g., commonly referred to as “perks”) including, for example, stock appreciation rights (SARS) granted by a company to one or more of its executives at one or more times. The SARS benefits are maintained in the financial planning system 100, as shown generally in a table format at 382 at FIG. 8A, and exhibited to the client 10 and advisor 12 to identify, for example, values, taxable amounts, grant and vesting schedules/periods, vesting percentages, and the like. In some embodiments, a current market value of one or more stocks subject to the SARS benefits is depicted at 386. In some embodiments, the SARS GUI 380 includes a summary of a value of shares held as well as values of vested gain and non-vested gain in the shares of the one or more stocks subject to the SARS benefit, generally at 388. The financial planning system 100 records this information to allow for a comprehensive financial strategy including, for example, advice on how and when to exit from each SARS option (e.g., exercise the option to sell a portion or all of the stock associated with the option). As should be appreciated, visibility to SARS option provides an understanding of estimated cash flow and possible tax implications based on the exercise of each SARS option tranche as well as allows for tracking a current market value of and/or expiration of the SARS options to ensure that the benefit is not unknowingly forfeited, and planning can be done to ensure a smooth transition in the exercise of the option to, for example, maximize financial benefit (e.g., a current favorable stock market value) and minimize adverse financial impact (e.g., tax impact), if any. For example, cash flow generated by the exercise (e.g., sale net taxes assessed against the sale) may be considered as part of planned assets and spending as defined by the advisor 12 and the client 10 using the UP GUI 330 (FIGS. 3A and 3B) and the BAL GUI 310 (FIGS. 2A to 2C). In some embodiments, selecting a control icon 384 provided at each line item of the table 382 invokes a SARS Exercise dialog box 385 depicted in FIG. 8B. As shown in FIG. 8B, in addition to providing a more detailed view of the corresponding SARS option, the SARS Exercise dialog box 385 exhibits a planned action for the SARS option, in an area shown generally at 385A and labeled “Recommended Exercise Schedule,” as well as an actual action taken on the SARS option, in an area shown generally at 385B and labeled “Actual Exercised,” which demonstrates a pattern of previous exercise of SARS options. At least one perceived benefit of providing the information presented in the SARS GUI 380 and the SARS Exercise dialog box 385 is seen to ensure that clients 10 make informed decisions when exercises the SARS benefit and can also view information from previous exercises to compare to options for a current exercise.

Similar to the SARS GUI 380 (FIGS. 8A and 8B), the RSUS GUI 390 (FIG. 9) and the PSUS GUI 400 (FIG. 10) each exhibit further additional executive benefits beyond salary including, for example, restricted stock awards (RSUS) and performance stock awards (PSUS) granted by a company to one or more of its executives at one or more times. As shown in FIGS. 9 and 10, the RSUS and PSUS benefits are maintained in the financial planning system 100, as shown generally in table formats at 392 of FIG. 9 and at 402 of FIG. 10, and exhibited to the client 10 and advisor 12 to identify, for example, values, taxable amounts, grant and vesting periods/schedules, percentages, and the like, for the respective benefits.

As shown in FIG. 11, the Assets GUI 410 exhibits a summary of all assets, by asset type, and provides information on which and how assets are to be dispositioned upon death of a specified one of the clients 10. It should be appreciated that it is within the scope of the present disclosure for the term “all assets” to include not only those assets held by the advisor's 12 firm but also all other assets of the client and/or client-household such that financial planning considers the client's full financial portfolio. In some embodiments, the financial planning system 100 includes a GUI, for example, a Tax GUI, presenting a side-by-side summary of information from federal and/or state tax returns filed by the client and/or client-household by one or more tax years (e.g., a 5-year summary of returns). In some embodiments, a source document (e.g., annual tax return) for the summary information may be accessed and viewable through the Tax GUI. The Tax GUI may depict information in categories or areas of, for example, income, adjusted gross income, taxes incurred, credits, taxable income, total tax incurred, payments made to accrued tax liability, notes on such information, average rates of federal and/or state taxes, carryover deductions, and the like. In some embodiments, the Tax GUI provides information to the advisor 12 to assist the client 10 makes financial decisions considering actually and potential tax liability (e.g., within a current tax bracket before entering a next bracket to avoid, for example, incurring a higher income tax rate), and to make mid-year decision to minimize adverse impact by, for example, considering a Roth 401k conversion, where funds are moved from a pre-tax retirement account, like a traditional IRA, 401k, or like account, into a Roth IRA. Moreover, the advisor 12 having multiple years of tax information at hand may determine trends and, in some cases, potential errors on tax returns, given a side-by-side comparison of such tax information. As can be appreciated, a thorough financial plan of a client and/or client-household should consider, and as shown in FIG. 11, the system 100 documents disposition of the client's assets on death and/or significant disability. In some embodiments, the Assets GUI 410 defines, for example, primary and contingent beneficiaries for specific ones of the client's assets.

As shown in FIGS. 12A and 12B, the DOCS GUI 420 exhibits a summary of legal documents addressing a client's financial planning including, for example, trusts, wills, living wills, powers of attorney, other estate planning documents, and the like. In some embodiments, a source document (e.g., an executed will or power of attorney document) may be selectively accessed and viewable through the DOCS GUI 420. In some embodiments, the DOCS GUI 420 also exhibits beneficiary information including, for example, a type of beneficiary (e.g., primary or contingent), allocation of ownership (e.g., ownership percentage, partial up to one hundred percent (100%)), order, and/or provisions of document (e.g., spendthrift, generation skipping, and the like). In some embodiments, the advisor 12 and client 10 use the DOCS GUI 420 to record documentation on how assets (both within the system 100 and held everywhere) may pass or transfer on death or incapacity of clients and/or client-households to their family or others, and/or, as needed, identify missing documentation and/or a need to address one or more questions and/or issues (e.g., death of a beneficiary and the like) with the documents that a client should discuss with other advisers, for example, legal counsel, to resolve the questions and/or issues. As described herein, the documents for the client 10 may be stored in the client's profile 162 within the data storage device 160 and/or within the CRM data store 198 and/or be provided to the TCP APP 124A, 154A, 160A by the CRM processor 194. Accordingly, the DOCS GUI 420 provides a comprehensive view of documentation planned to guide the client's and/or client-household's estate planning within their overall financial plan. Periodic reviews of the information within the DOCS GUI 420 also identifies areas and/or documentation that may have become outdated or obsolete to trigger further action to review and update the documentation, as needed.

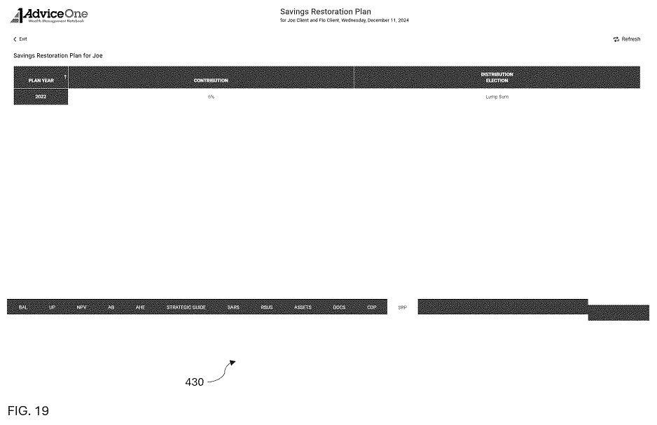

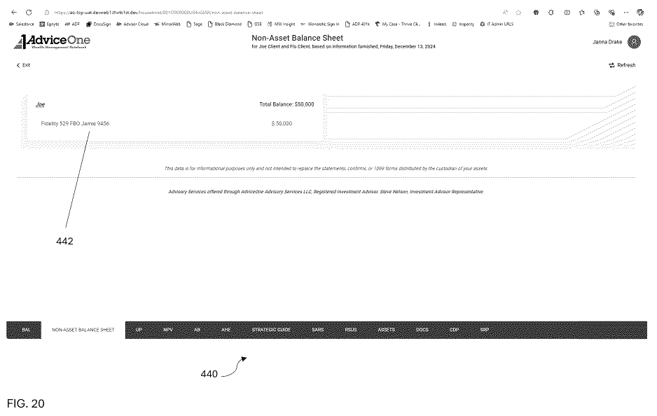

In some embodiments, the Front End GUIs 300 also include a Savings Restoration Plan (SRP) GUI 430 as depicted on FIG. 19. The SRP GUI 430 documents a compensation benefit provided to some executives of some corporation, namely, a non-qualified deferred compensation plan established and maintained for the purpose of providing some highly compensated employees with matching contributions that they are precluded from receiving under a corporation's 401 Retirement and Savings Plan provided to other employees as a result of limitations imposed under Internal Revenue Code. In some embodiments, the client 10 and advisor 12 leverage the SRP GUI 430 to determine financial impact of signing up for and taking various payout options under the client's company sponsored SRP. In some embodiments, the information exhibited on the SRP GUI 430 may be replaced on the client's balance sheet (e.g., as exhibited on the BAL GUI 310 of FIGS. 2A to 2C) as the client gets closer to retirement and when the payout is depicted as a stream of income on, for example, the client's balance sheet (e.g., on the BAL GUI 310 of FIGS. 2A to 2C) and as a non-asset on the UP GUI 330 (FIGS. 3A and 3B) for assets transferred to alternative ownership yet within the client's control, for example, such as part of a tax-advantage investment account for education typically referred to as a 529 plan. As should be appreciated, transferred assets still within the control of the client 10 are part of the client's overall financial portfolio. Accordingly, in some embodiments, the Front End GUIs 300 of the financial planning system 100 include a Non-Asset Balance Sheet GUI 440 as depicted in FIG. 20. As shown in FIG. 20, the Non-Asset Balance Sheet GUI 440 includes a 529 Educational Account 442 for a dependent of the client 10, e.g., “Joe Client” and his dependent named “Jamie.” As should be appreciated, items within the Non-Asset Balance Sheet may technically no longer be a part of the client's estate and therefore not presented on the client's balance sheet (e.g., on the BAL GUI 310). Other financial accounts may be exhibited on the Non-Asset Balance Sheet including, for example, irrevocable trusts, or other trusts in which the client 10 may be named as a trustee, for example.

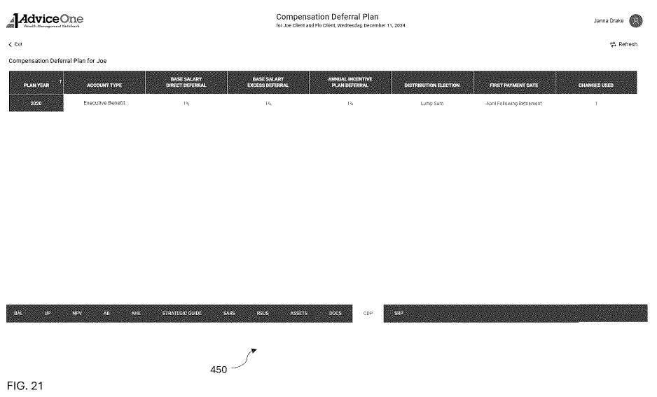

In some embodiments, the Front End GUIs 300 may also include a Compensation Deferral Plan (CDP) GUI 450 as depicted on FIG. 21. The CDP GUI 450 documents a deferred compensation plan that allows an employer to defer a part of their employee's (e.g., typically an executive's) income so that the employee would pay taxes on the income at a later date, for example, when the employee starts withdrawing income from the plan.

### Back End GUIs

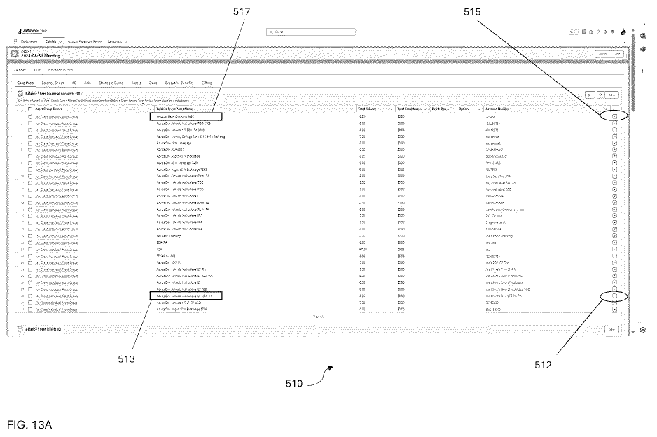

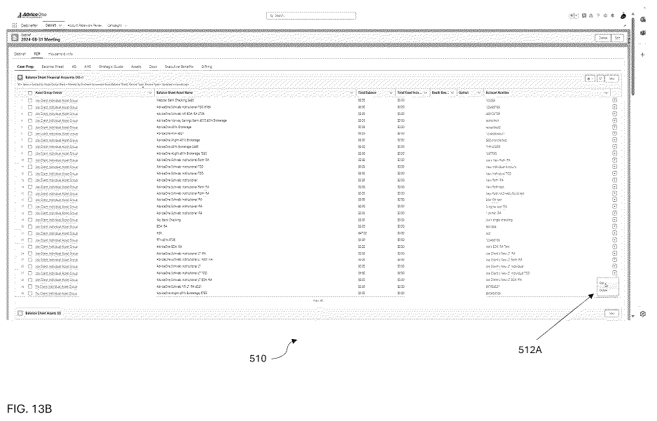

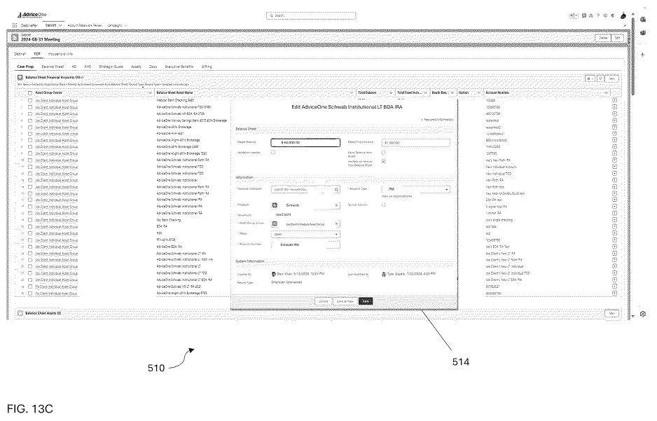

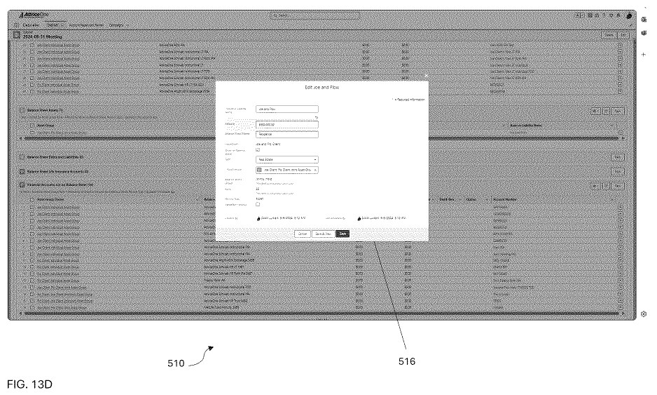

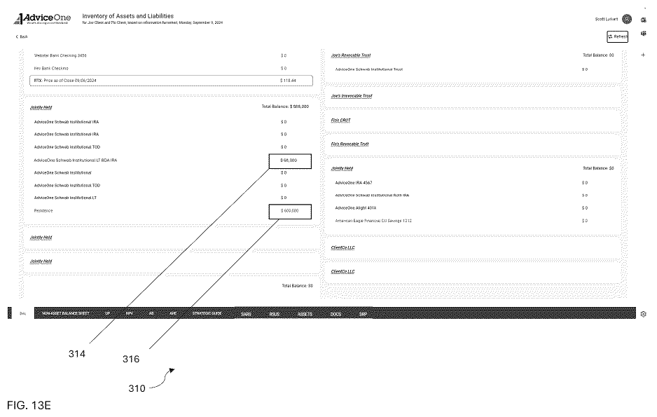

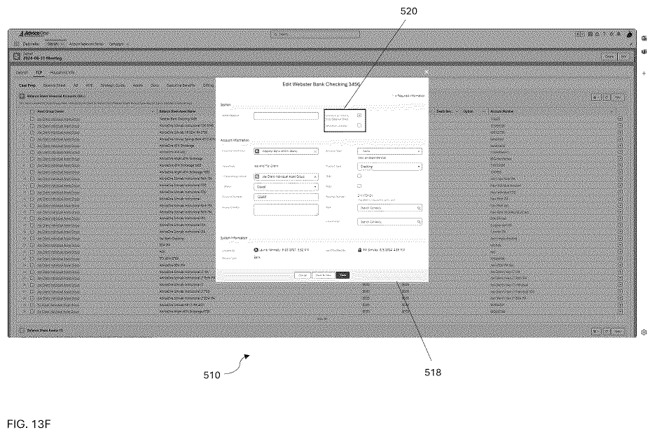

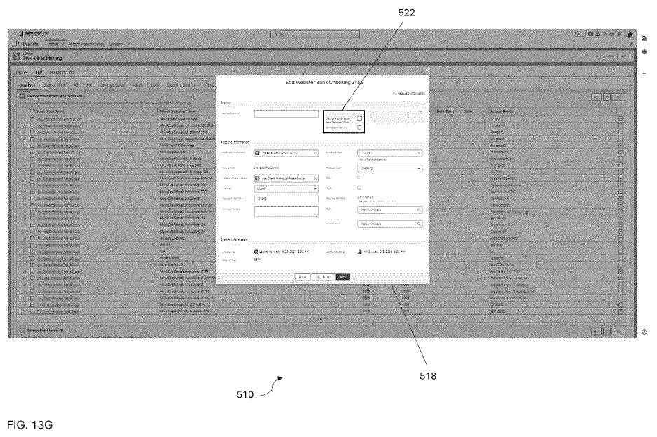

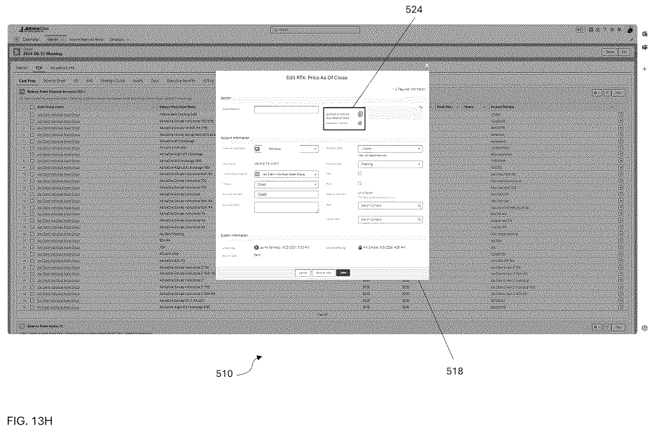

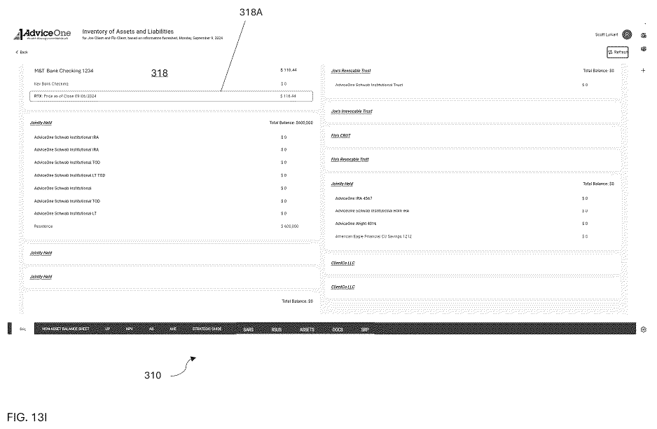

In some embodiment, the Back End GUIs 500 include GUIs that mirror data and information exhibited on the Front End GUIs 300 and which provide functionality for modifying the data presented on the Front End GUIs 300 such as, for example, changing values, adding or deleting data, and the like. For example, the Back End GUIs 500 include a Case Preparation (Case Prep) GUI 510 as depicted on FIGS. 13A to 13D that may be operated to updated data on the Balance Sheet GUI 310 as depicted on FIG. 13E. As shown in FIG. 13A, the Case Prep GUI 510 includes dropdown menu control elements corresponding to each data item presented on the Case Prep GUI 510, e.g., control elements 512 and 515 corresponding to an individual retirement account (IRA) asset labeled “AdviceOne Schwab Institutional LT BDA IRA” 513 and a bank checking account asset labeled “Webster Bank Checking 3456” 517, respectively. In some embodiments, when one of the dropdown menu control elements is selected, the TCP APP 124A, 154A, 160A invokes an Edit/Delete Dialog Box 512A, as shown in FIG. 13B, that allows a next selection of an “Edit” or a “Delete” operation to be performed on the data item corresponding to the dropdown menu control element. If the Edit operation is selected on the Edit/Delete Dialog Box 512A, the TCP APP 124A, 154A, 160A invokes an Edit Dialog Box 514, as shown in FIG. 13C, that exhibits values of the data item associated with the dropdown menu control element, e.g., the IRA asset AdviceOne Schwab Institutional LT BDA IRA 513 associated with the dropdown menu control element 512 (FIG. 13A). Similarly, as shown in FIG. 13D, the TCP APP 124A, 154A, 160A invokes an Edit Dialog Box 516 that exhibits and allows update to values of another data item within the client's profile, e.g., a residence asset. As shown in FIG. 13E, new values entered on the Edit Dialog Boxes 514 and 516 for the AdviceOne Schwab Institutional LT BDA IRA 513 (FIG. 13A) and the residence asset are exhibited on the BAL GUI 310 exhibited to the clients at 314 and 316, respectively.

As shown in FIGS. 13F, 13G, and 13H, the Case Prep GUI 510 may also be operated to remove data on the BAL GUI 310 or to indicate that data must be “validated” (e.g., where an advisor 12 asks the client 10 for a current status of the corresponding asset or liability exhibited on the BAL GUI 310) as depicted on FIG. 13I. For example, as shown in FIG. 13F, an Edit/Delete Dialog Box 518 includes one or more Check Box Control elements shown generally at 520. The Check Box Control elements 520 may be associated with operations to, for example, remove a data item from the BAL GUI 310 (e.g., element labeled “Unlock to remove from Balance Sheet”) or to indicate that the data item should be “validated” (element labeled “Validation needed”). In some embodiments, an action to delete data may invoke a two-step process, where a dialog box is presented requesting a confirmation before completion of the deletion operation. In one embodiment, validation includes requesting that the client provide a current status of the asset, e.g., a current value or an indication whether the client performed a certain action on the asset (remitted an optional or required payment, redeemed the asset or a portion thereof, and the like). As shown by comparing the Check Box Control elements 520 within the Edit/Delete Dialog Box 518 of FIG. 13F to Check Box Control element 522 of FIG. 13G and to Check Box Control element 524 of FIG. 13H, the TCP APP 124A, 154A, 160A performs a delete operation (e.g., unchecked control 522) for the Webster Bank Checking 3456 asset 517 (FIG. 13A) and performs a validation required operation (e.g., checked control 524) for an asset labeled “RTX: Price at Close.” As shown in FIG. 13I, the Webster Bank Checking 3456 asset 517 (FIG. 13A) is now removed from the exhibited list of assets, shown generally at 318, and the “RTX: Price at Close” asset is highlighted with, for example, a “green” box at 318A, as a notification to the advisor 12 or debriefer 14 to inquire as to the status of the asset with the client 10.

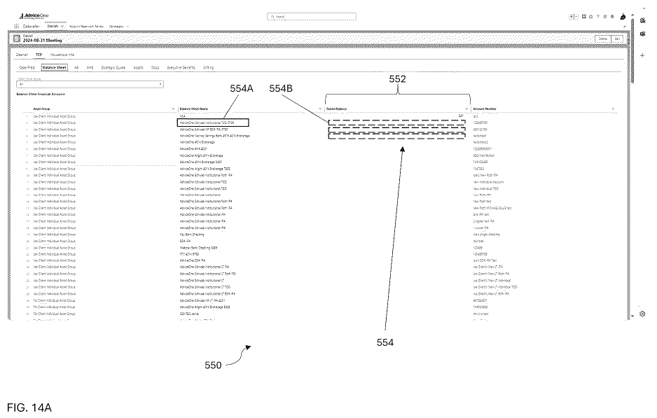

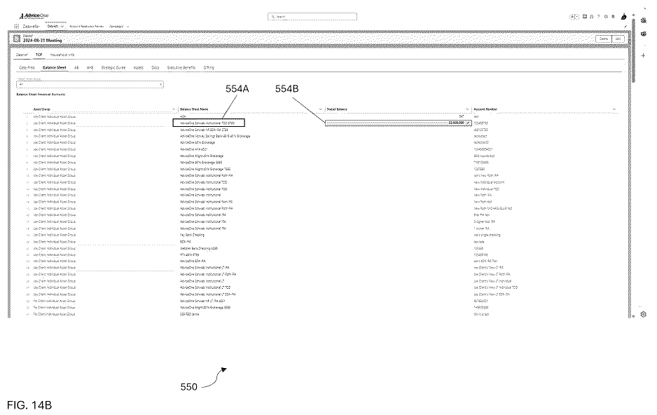

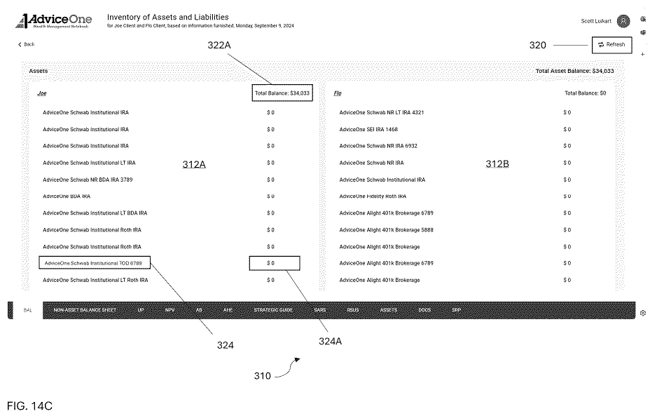

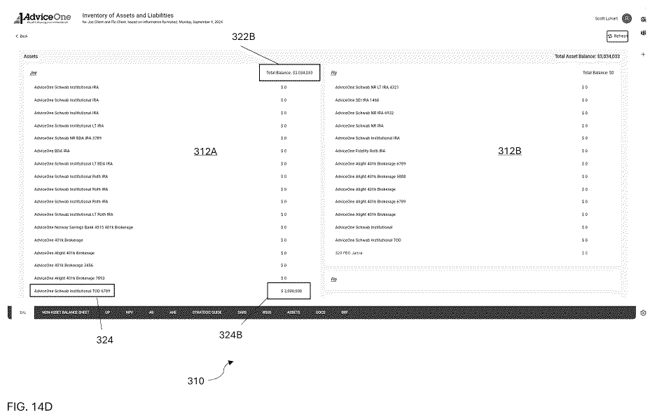

The Back End GUIs 500 may also include a Debriefer's Balance Sheet GUI 550 as depicted on FIGS. 14A and 14B that may be operated to update data on the Balance Sheet GUI 310 as depicted on FIGS. 14C and 14D. As described below, in some embodiments, the Debriefer's Balance Sheet GUI 550 is seen to permit a more efficient manner for updating numerous data items within a client's profile. In some embodiments, as shown in FIG. 14A, the Debriefer's Balance Sheet GUI 550 may include a data entry column, shown generally at 552, that includes a plurality of individual fields, shown generally at 554, corresponding to one or more of the assets, debts and liabilities, life insurance, and/or other financial data of individual or related (client-household) clients 10, typically exhibited on the BAL GUI 310 for the client(s) 10. For example, as shown in FIGS. 14A and 14B, an asset 554A labeled “AdviceOne Schwab Institutional TOD 6789” is related to a field 554B in the data entry column 552. The value of the asset 554A is revised at field 554B as shown in FIG. 14B, e.g., a value of “$3,000,000” is entered at field 554B for the asset 554A. The TCP APP 124A, 154A, 160A receives and saves the updated value in the client profile for the client (e.g., one of the client profiles 162 Client 1 Profile to Client Z Profile for clients 10) within the data storage device 160 (FIG. 1). As shown in FIGS. 14C and 14D, the updated data value 554B (FIG. 14B) for the asset 554A is presented to the client 10 (exhibited on BAL GUI 310 as the value 324B corresponding to asset 324 (FIG. 14D)) after selection of a Refresh control element 320 (FIG. 13C), where in response to the Refresh request the TCP APP 124A, 154A, 160A performs a refresh operation by retrieving the stored data value for the asset 554A and exhibits the updated value 324B for asset 324 on the BAL GUI 310 (e.g., an initial value 324A for the asset 324 (FIG. 14C) is replaced with the updated value 324B (FIG. 14D)). In some embodiments, the BAL GUI 310 includes an exhibition of a total value of a class of assets, liabilities, life insurance, and other financial data shown. As shown in FIGS. 14C and 14D, a Total Balance field 322A provides an initial total value for the assets exhibited 312A and 312B before the refresh operation, and a Total Balance field 322B provides an updated total value for the assets exhibited 312A and 312B after the refresh operation. As shown in FIGS. 14C and 14D, a zero dollar data value ($ 0) shown at 324A for an asset 324 labeled “AdviceOne Schwab Institutional TOD 6789” and a thirty four thousand thirty-three dollar data value (“$34,033”) for the Total Balance field at 322A before the refresh operation, is updated to a data value at 324B of “$3,000,000” for the asset 324 and a data value of “$3,034,033” for a Total Balance field at 322B after the refresh operation.

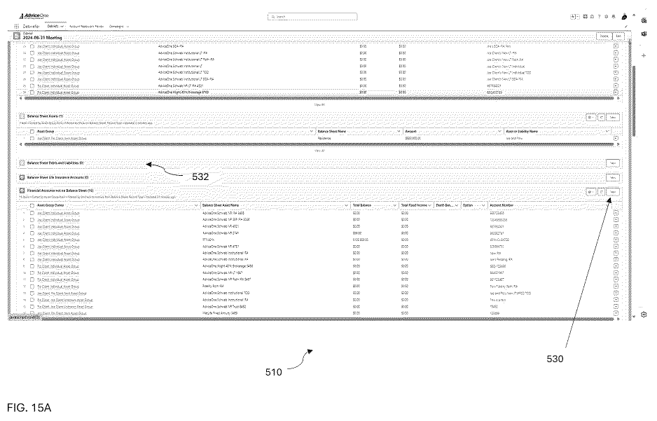

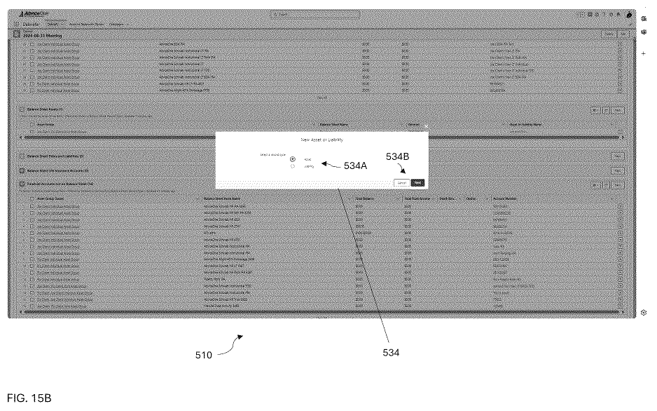

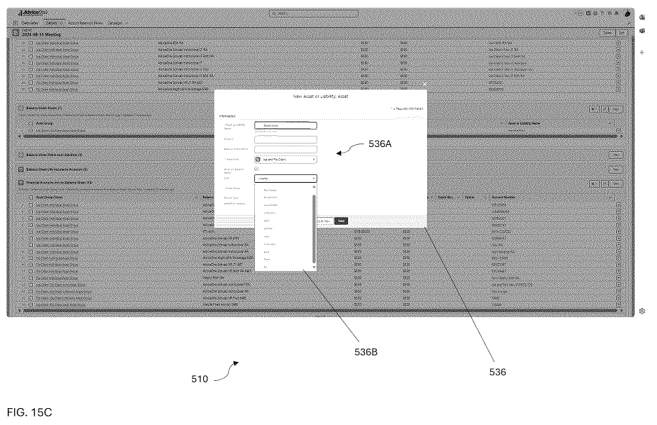

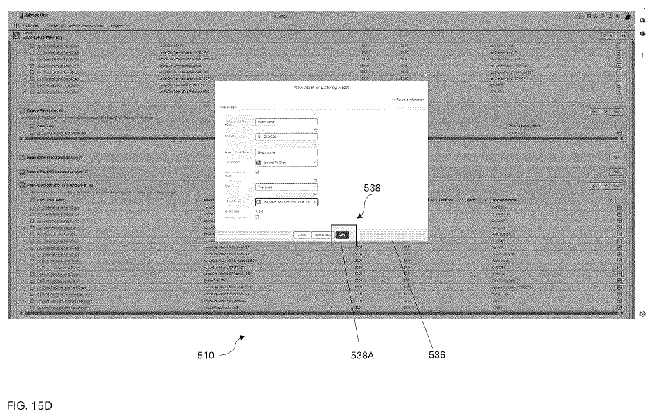

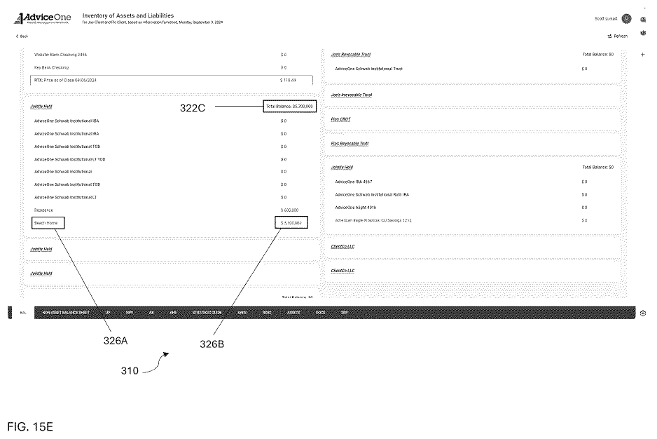

In some embodiments, as shown in FIGS. 15A to 15D, the Case Prep GUI 510 may also include one or more “New” control elements, shown generally at 530, to invoke an operation to add a new entry for the one or more classes of assets, debts and liabilities, life insurance and/or other financial data, shown generally at 532 (FIG. 15A). As shown in FIGS. 15B to 15D, in response to selection of one of the New control elements 530, a new object request is sent to the TCP APP 124A, 154A, 160A which exhibits a series of Dialog Boxes 534 (FIGS. 15B) and 536 (FIGS. 15C and 15D) to receive the data and to create a new one of the assets, debt and liabilities, life insurance, and/or other financial data 532. For example, as shown in FIG. 15B, the TCP APP 124A, 154A, 160A exhibits the Dialog Box 534 where a record type (e.g., asset or liability) is selected with one or more radio buttons shown at 534A. Once the record type is selected, the TCP APP 124A, 154A, 160A saves the value and invokes the Dialog Box 536 for further data entry, in response to selection of a “Next” control, shown generally at 534B, or discards the entry and quits the Dialog Box 534 in response to selection of a “Cancel” control, also shown at 534B. As shown in FIG. 15C, the TCP APP 124A, 154A, 160A exhibits the Dialog Box 536 to receive data values for the new one of the assets, debt and liabilities, life insurance, and/or other financial data 532. For example, the Dialog Box 536 exhibits data fields, shown generally at 536A, including a general name, amount or financial value, name to be exhibited in the BAL GUI 310, and type, for example. In some embodiments, the type data value may be entered with selection of a predefined entry on a dropdown menu, as shown generally at 536B. As shown in FIGS. 15C and 15D, the new asset has a general name “Beach home” and a type “Real Estate” selected from the dropdown menu 536B and other options of, for example, “Equipment,” “Automobile,” “Collection,” “Gold,” “Jewelry,” “Cash,” “Timeshare,” “Boat,” “Plane,” and “RV.” As shown in FIG. 15D, once all required data fields include input data, the Dialog Box 536 exhibits control elements, shown generally at 538, to save and close the Dialog Box 536 (“Save” control), save and continue entry of another new entry for the one or more classes of assets, debts and liabilities, life insurance and other financial data (“Save & New” control), or to quit the current input of a new entry (“Cancel” control). In response to a selection of the Save control 538A, the TCP APP 124A, 154A, 160A creates and stores (e.g., within the client profile 162 for the corresponding client 10) the data values for the new one of the assets, debt and liabilities, life insurance, and/or other financial data 532 within the corresponding Class 164. If the “Save & New” control is selected, the TCP APP 124A, 154A, 160A creates and stores the new one and reinvokes the Dialog Box 534 to allow input of another entry. Alternatively, if the “Cancel” control is selected, the TCP APP 124A, 154A, 160A clears the data entries and closes the Dialog Box 536, returning control to the Case Prep GUI 510. Once input of data is completed, the client 10, advisor 12, and/or debriefer 14 may invoke the BAL GUI 310 to view the result of any previously performed data entry operations. For example, as shown in FIG. 15E, the BAL GUI 310 may exhibit the new asset “Beach Home” at 326A, its entered dollar value “$5,100,000” at 326B, and a resulting update to a “Total Balance” value to “5,700,000” at 322C.

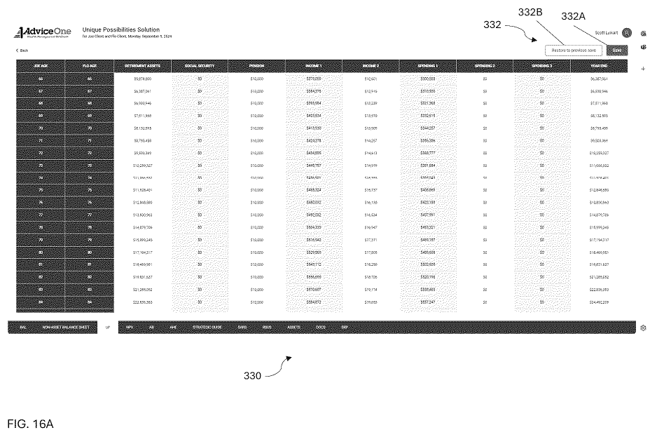

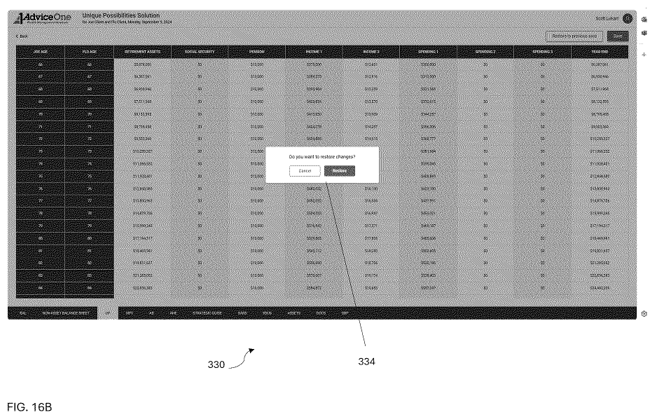

As noted above, the client 10 and/or their advisor 12 and/or debriefer 14 may review the client's profile by exercising one or more of the GUIs 250 (e.g., the Front End GUIs 300 and Back End GUIs 500) in an interactive, collaborative, face-to-face or remote financial planning meeting. In some embodiments, the face-to-face or remote meeting may include one or more simulations of the performance of the client's financial portfolio as stored in the client's profile 162 when an attribute of one or more of the one of the assets, debt and liabilities, life insurance, and/or other financial data 532 within the created classes 164 are changed. In some embodiments, the change may include changing a dollar value of the financial data 532, removing one of the assets, liabilities, income and/or expenses from the stored classes 164, or adding a new one of the assets, liabilities, income and/or expenses to the stored classes 164. In some embodiments, the simulated performance may include an increase, a decrease, or no change to the total balance of the client's financial data. In some embodiments, based on the simulated performance, the client 10, advisor 12, and/or debriefer 14 may conclude that the simulated performance is favorable to the client and accordingly, it is desirable to modify one or more of the financial planning recommendations and plans 168 to adopt the changed attribute of one or more of the client's financial data to maintain or achieve one of the client's financial planning goals 166 and/or to achieve a new financial planning goal 166. In some embodiments, based on the simulated performance, the client 10, advisor 12, and/or debriefer 14 may conclude that the simulated performance is not favorable to the client and accordingly, it is desirable to discard the changed attribute. As shown in FIGS. 16A and 16B, in some embodiments, one or more of the Front End GUIs 300 and Back End GUIs 500 may include control elements, shown generally at 332 on the UP GUI 330 (FIG. 16A), that requests that the TCP APP 124A, 154A, 160A saves and stores the changed attribute in the client's client profile 162 (“Save” control 332A) or discards the changed attribute and return to a previously saved version of the client's client profile 162 (“Restore” control 332B). As shown in FIG. 16B, in some embodiments, selection of the Restore control 332B invokes a Restore Dialog Box 334 wherein the TCP APP 124A, 154A, 160A requests confirmation of the command to discard the simulation and to restore data values to a previously stored version of the client's client profile 162.

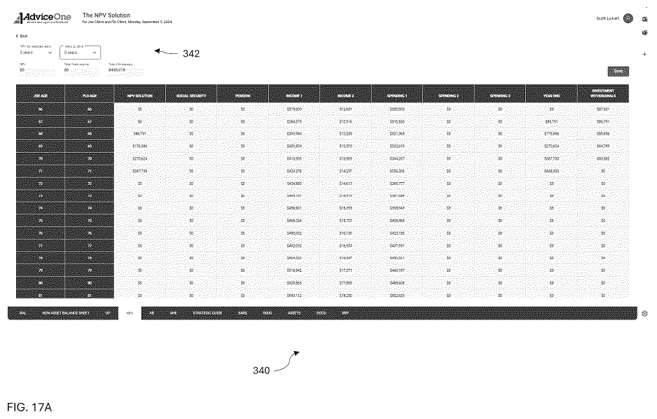

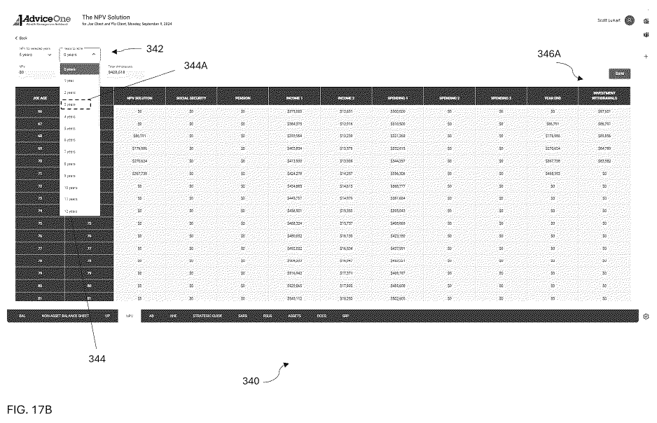

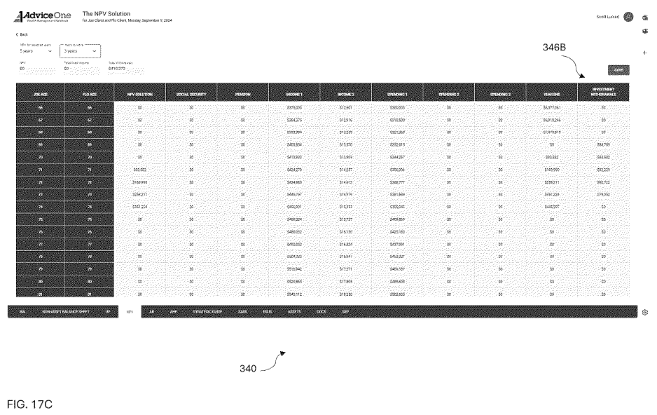

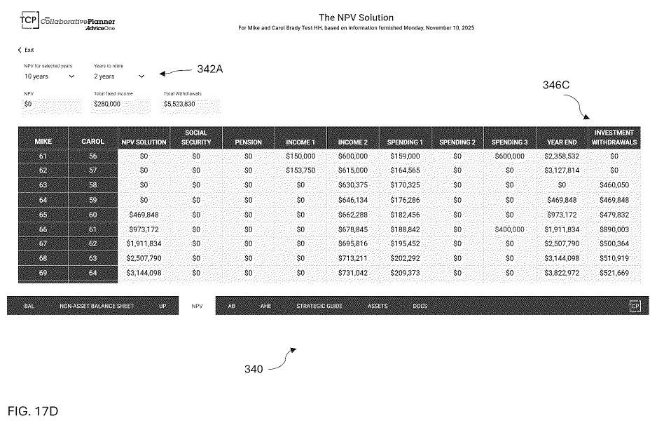

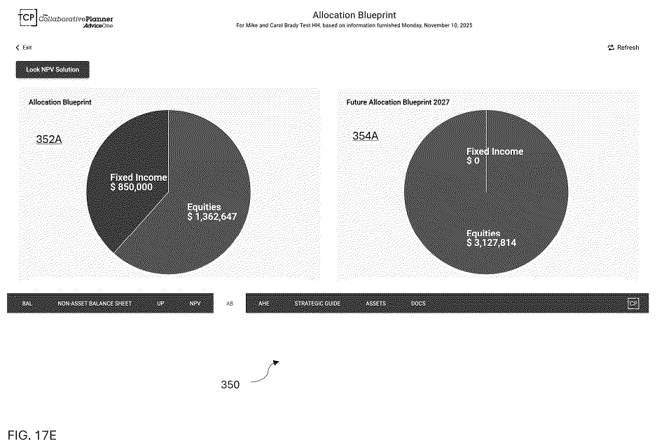

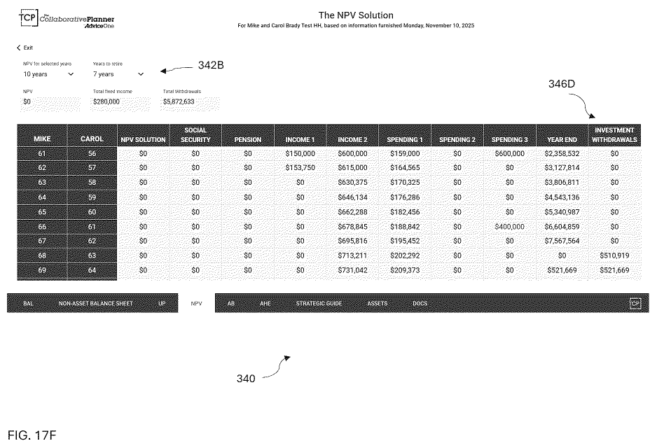

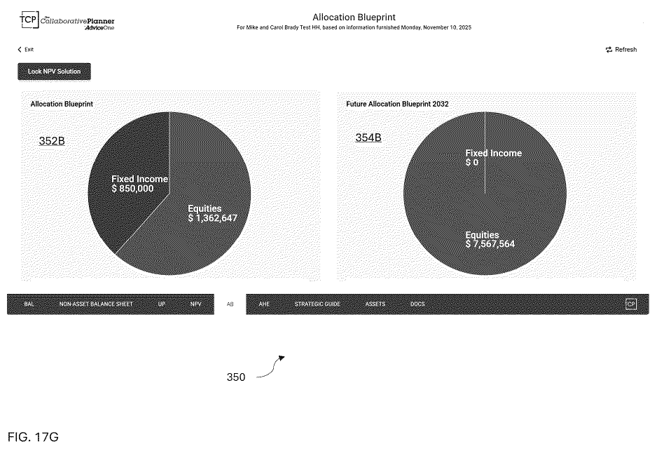

As shown in FIGS. 17A to 17C, in some embodiments, the simulation may include a simulation of the performance of the client's profile 162 when the client makes a decision to revise his or her previously planned date or year of retirement, and the resulting impact of that decision on values of the one or more of assets, debt and liabilities, life insurance, and/or other financial data (e.g., depicted on the Case Prep GUI 510 (FIGS. 15A to 15D) at 532) within the created classes 164 of the client's client profile 162 is calculated and presented to the client 10 by the TCP APP 124A, 154A, 160A. As shown in FIG. 17A, Joe Client and Flo Client are currently retired, as shown generally in the fields provided at 342 on the NPV Solution GUI 340 (e.g., “Years to retire” having a value of “0”), and their current income and spending levels as well as their anticipated withdrawals from their investments are presented within columns on the NPV Solution GUI 340. As shown in FIG. 17B, the client 10, the advisor 12, and/or the debriefer 14 may simulate performance of Joe Client and Flo Client's client profile 162, by altering a proposed date of retirement by activating a dropdown menu control element 344 within the fields 342 and selecting a new value 344A of, for example, “3 years.” The impact of that simulation is presented on the NPV Solution GUI 340 as shown in FIG. 17C where, for example, no withdrawals are made from the client's investments until the client retires, as shown generally by comparing withdrawals made during retirement at 346A (FIG. 17B) to withdrawals deferred until retirement in 3 years shown at 346B (FIG. 17C). While not shown in FIG. 17C, it should be appreciated that the NPV Solution GUI 340 may include control elements, similar to elements 332 on the UP GUI 330 (FIG. 16A), that requests that the TCP APP 124A, 154A, 160A to save and store the changed retirement date within Joe Client's and Flo Client's client profile 162 or to discard the simulated change of retirement age and to return to a previously saved version of Joe Client's and Flo Client's client profile 162. It should be appreciated that changes to assumptions made within the client's financial plan, for example, a decision to retire earlier or later than first planned, may also impact amounts (e.g., funds) allocated to fixed income versus equity, as typically illustrated to the client on the AB GUI 350 (FIG. 5). For example, as shown in FIG. 17D, clients Mike and Carol Brady plan to retire in “2 years,” as shown generally in the fields provided at 342A and where no withdrawals are made from the client's investments until the client retires in two years, as shown generally at 346C on the NPV Solution GUI 340 of FIG. 17D, and the AB GUI 350 reflects the allocations to fixed income and equity currently at 352A and at retirement in two years (e.g., in 2027) at 354A of FIG. 17E. If, for example, during a financial planning meeting with their advisor 12, clients Mike and Carol Brady wish to consider retiring in “7 years”, as shown generally in the fields provided at 342B and where no withdrawals are made from the client's investments until the client retires in seven years, as shown generally at 346D on the NPV Solution GUI 340 of FIG. 17F, and the AB GUI 350 reflects the allocations to fixed income and equity currently at 352B and at retirement in seven years (e.g., in 2032) at 354B of FIG. 17G.

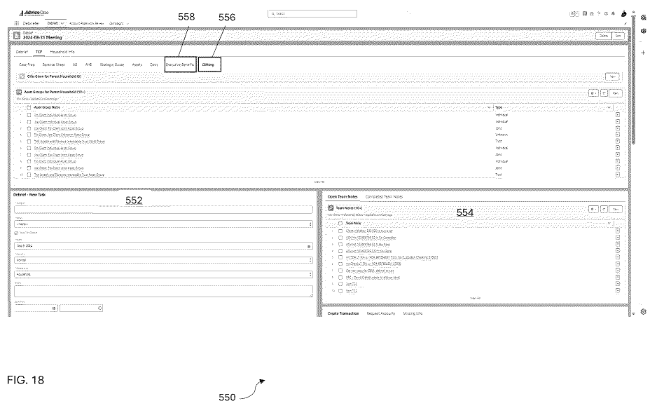

As shown in FIG. 18, the Back End GUIs 500 may include a Gifting GUI 550, e.g., when a “Gifting” tab 556 is selected, for documenting one or more distributions from a client's assets or income to a third-party such as, for example, a dependent. For example, in some embodiments, as shown in FIG. 18, the Gifting GUI 550 includes a first section, shown generally at 552, for entry of data documenting a new distribution and a second section, shown generally at 554, including a history of previous distributions/gifts. As also shown in FIG. 18, the Gifting GUI 550 may include an “Executive Benefits” tab 558 to invoke GUIs for reviewing executive benefits such as, for example, are exhibited on the SARS GUI 380 (FIGS. 8A and 8B), the RSUS GUI 390 (FIG. 9), and the PSUS GUI 400 (FIG. 10).

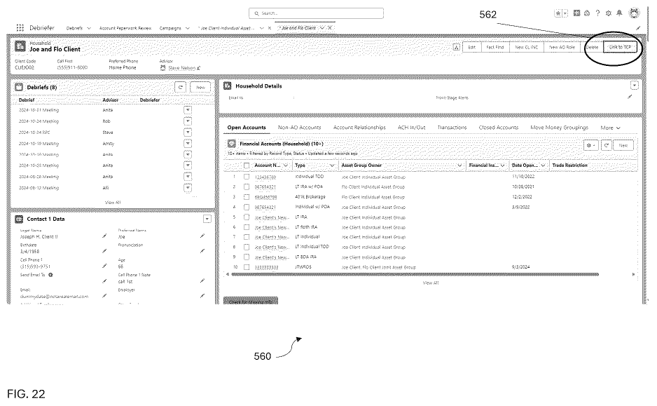

As described herein, in some embodiments, documents for the client 10 may be stored in the client's profile 162 within the data storage device 160 and/or within the CRM data store 198 and provided to the TCP APP 124A, 154A, 160A by the CRM processor 194. As shown in FIG. 22, a CRM application GUI 560 depicts accounts and other information processed by the CRM application such as, for example, a Salesforce CRM software application, executed on the CRM processor 194 to exhibit data and information stored therein for the client 10 of the financial planning system 100. As shown in FIG. 22, in some embodiment, the CRM application GUI 560 includes a control button 562 (e.g., labeled “Link to TCP”) to link the CRM application (e.g., SalesForce) to the TCP APP 124A, 154A, 160A of the financial planning system 100, which is invoked on selection of the control button 562.

It should be appreciated that the phraseology and the terminology used in the description of the various embodiments described herein should be given their broadest interpretation and meaning as the purpose is for describing particular embodiments only and is not intended to be limiting. As used in the description of the various described embodiments and the appended claims, the singular forms “a,” “an,” and “the” are intended to include the plural forms as well, unless the context clearly indicates otherwise. It should also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, and equivalents thereof, and do not preclude the presence or addition of one or more other features, integers, steps, operations, elements, components, groups and/or equivalents thereof. It should also be understood that the term “computer program product” includes logic presented by computer code and instructions embodied in or on the computer program product that is executed and executable by one or more computing devices to implement and/or perform functionality or operations as described herein.

While the invention has been described with reference to various exemplary embodiments, including, for example, an implementation as a financial planning system that evaluates a client's financial data, creates classes for the financial data, and generates financial planning recommendations and financial plans including a calculated allocation of funds between the classes to maintain and achieve one or more financial goals of the client, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as an exemplary or best mode contemplated for carrying out this invention, but that the invention will include all embodiments falling within the scope of the appended claims.

What is claimed is:

1. A system for financial planning, comprising:
a server including a server processor and a server memory operatively coupled to the server processor, the server memory storing server instructions executable by the server processor; and
one or more user devices, operable by one or more users of the system, each of the one or more user devices including a user device processor, a user device memory operatively coupled to the user device processor, and a user device display operatively coupled to the user device processor and exhibiting a plurality of graphical user interfaces (GUIs) thereon, the one or more user devices communicating with the server over a communication network, each of the user device memory storing user device instructions executable by the user device processor;
the server processor, when executing the server instructions, is configured to:
receive financial data of at least one client;
evaluate the received financial data and create at least one of one or more classes of assets, one or more classes of liabilities, one or more classes of income, one or more classes of expenses, or financial goals for the at least one client from the received financial data;
store, within the server memory, a client profile for the at least one client, the client profile including the at least one of the created classes of assets, liabilities, income, expenses, or financial goals for the at least one client;
generate one or more initial financial planning recommendations and an initial financial plan for the at least client, the initial financial planning recommendations and the initial financial plan including calculations of income and spending over a specified period of years, calculations of an allocation of funds between the created classes of assets, liabilities, and expenses within the initial financial plan to at least one of maintain or achieve the financial goals of the at least one client, and store the generated one or more initial financial planning recommendations and the initial financial plan in the client profile;
update the stored client profile for the at least one client upon receipt of at least one of new values for the at least one of the created classes of assets, liabilities, income, expenses, or financial goals for the at least one client or a request generated by one of the one or more user device processors by recalculating the income and spending over the specified period of years and recalculating the allocation of funds to generate updated financial planning recommendations and an updated financial plan based on the new values to at least one of maintain the created financial goals or new financial goals for the at least one client; and
host the plurality of GUIs for monitoring and updating at least one of the stored client profile or the one or more initial and updated financial planning recommendations and the initial and update financial plan for the at least one client;
the user device processor, when executing the user device instructions, is configured to:
monitor, by invoking one of the plurality of GUIs, the client profile and progress of the one or more initial and updated financial planning recommendations and the initial and updated financial plan toward the created financial goals or the new financial goals for the at least one client;
update, by invoking one of the plurality of GUIs, a value of one or more of the created classes of assets, liabilities, income, expenses, or financial goals and generate a request to the server processor to update the stored client profile to reflect the updated value;
simulate performance of the client profile based on changing at least one attribute of at least one of the created classes of assets, liabilities, income, or expenses or a duration of the specified period of years;
based on the simulated performance, modify the one or more initial or updated financial planning recommendations and the initial or updated financial plan with the at least one changed attribute to at least one of maintain the created financial goals or the new financial goals for the at least one client; and
generate the request to the server processor to update the stored client profile for the at least one client to include the modified one or more initial or updated financial planning recommendations and the initial or updated financial plan.

2. The system of claim 1, wherein the profile data further includes at least one of age of the client, marital status of the client, gender of the client, and the age and gender of the client's partner, dependents, and beneficiaries, details relating to the assets and liabilities, information relating to the financial goals, and their priority in terms of dollar value and timing, anticipated expenses, anticipated income, anticipated large expenditures including educational expenses, home ownership expenses, travel expenses, account beginning balances, retirement start date, rate of inflation, preferred retirement income distribution strategy, or projected expenses.

3. The system of claim 1, wherein the created financial goals and the new financial goals are each comprised of a financial position goal, a retirement goal, an education goal, a major purchase goal, a cash reserve goal, an income tax goal, an investment planning goal, an employee benefits planning goal, a survivor income goal, a disability income goal, a long term care planning goal, a healthcare planning goal, a property and casualty planning goal, an estate planning goal, a divorce planning goal, a financial planning goal of a business owner, or any combination of the foregoing.

4. The system of claim 1, wherein the new value of one or more of the assets, liabilities, income, or expenses for the at least one client is automatically transmitted to the server processor by a notification message generated at a close of financial markets.

5. The system of claim 1, wherein the at least one attribute of the simulated performance includes at least one of changing a value, removing one of the assets, liabilities, income or expenses from the stored classes, or adding one of the assets, liabilities, income or expenses to the stored classes.

6. The system of claim 1, wherein the at least one attribute of the simulated performance includes at least one of increasing or decreasing the duration of the specified period of years within the calculation of income and spending under the updated financial plan to simulate that the at least one client retires at least one of later than initially planned or earlier than initially planned.

7. A computer implemented method for financial planning, the method comprising:
receiving, by a server computing device, financial data of at least one client;
evaluating, by the server computing device, the received financial data and creating at least one of one or more classes of assets, one or more classes of liabilities, one or more classes of income, one or more classes of expenses, or financial goals for the at least one client from the received financial data;
storing, within a server memory operatively coupled to the server computing device, a client profile for the at least one client, the client profile including the at least one of the created classes of assets, liabilities, income, expenses, or financial goals for the at least one client;
generating, by the server computing device, one or more initial financial planning recommendations and an initial financial plan for the at least client, the initial financial planning recommendations and the initial financial plan including calculations of income and spending over a specified period of years, calculations of an allocation of funds between the created classes of assets, liabilities, and expenses within the initial financial plan to at least one of maintain or achieve the financial goals of the at least one client, and storing the generated one or more initial financial planning recommendations and the initial financial plan in the client profile;
updating, by the server computing device, the stored client profile for the at least one client upon receipt of at least one of new values for the at least one of the created classes of assets, liabilities, income, expenses, or financial goals for the at least one client or a request, generated by one or more user computing devices, by recalculating the income and spending over the specified period of years and recalculating the allocation of funds to generate updated financial planning recommendations and an updated financial plan based on the new values to at least one of maintain the created financial goals or new financial goals for the at least one client; and
hosting, by the server computing device, a plurality of GUIs for monitoring and updating at least one of the stored client profile or the one or more initial and updated financial planning recommendations and the initial and update financial plan for the at least one client;
monitoring, by at least one of the one or more user computing devices, by invoking one of the plurality of GUIs, the client profile and progress of the one or more initial and updated financial planning recommendations and the initial and updated financial plan toward the created financial goals or the new financial goals for the at least one client;
updating, by the at least one user computing device invoking one of the plurality of GUIs, a value of one or more of the created classes of assets, liabilities, income, expenses, or financial goals and generating a request to the server processor to update the stored client profile to reflect the updated value;
simulating, by the at least one user computing device, performance of the client profile based on changing at least one attribute of at least one of the created classes of assets, liabilities, income, or expenses or a duration of the specified period of years;
based on the simulated performance, modifying by the at least one user computing device the one or more initial or updated financial planning recommendations and the initial or updated financial plan with the at least one changed attribute to at least one of maintain the created financial goals or the new financial goals for the at least one client; and
generating, by the at least one user computing device, the request to the server computing device to update the stored client profile for the at least one client to include the modified one or more initial or updated financial planning recommendations and the initial or updated financial plan.

8. The method of claim 7, wherein the profile data further includes at least one of age of the client, marital status of the client, gender of the client, and the age and gender of the client's partner, dependents, and beneficiaries, details relating to the assets and liabilities, information relating to the financial goals, and their priority in terms of dollar value and timing, anticipated expenses, anticipated income, anticipated large expenditures including educational expenses, home ownership expenses, travel expenses, account beginning balances, retirement start date, rate of inflation, preferred retirement income distribution strategy, or projected expenses.

9. The method of claim 7, wherein the created financial goals and the new financial goals are each comprised of a financial position goal, a retirement goal, an education goal, a major purchase goal, a cash reserve goal, an income tax goal, an investment planning goal, an employee benefits planning goal, a survivor income goal, a disability income goal, a long term care planning goal, a healthcare planning goal, a property and casualty planning goal, an estate planning goal, a divorce planning goal, a financial planning goal of a business owner, or any combination of the foregoing.

10. The method of claim 7, wherein the new value of one or more of the assets, liabilities, income, or expenses for the at least one client is automatically transmitted to the server computing device by a notification message generated at a close of financial markets.

11. The method of claim 7, wherein the at least one attribute of the simulated performance includes at least one of changing a value, removing one of the assets, liabilities, income or expenses from the stored classes, or adding one of the assets, liabilities, income or expenses to the stored classes.

12. The method of claim 7, wherein the at least one attribute of the simulated performance includes at least one of increasing or decreasing the duration of the specified period of years within the calculation of income and spending under the updated financial plan to simulate that the at least one client retires at least one of later than initially planned or earlier than initially planned.

13. A computer program product for financial planning that when executed by one or more processors, causes the one or more processors to:
receive financial data of at least one client;
evaluate the received financial data and create at least one of one or more classes of assets, one or more classes of liabilities, one or more classes of income, one or more classes of expenses, or financial goals for the at least one client from the received financial data;
store, within non-transitory, computer readable storage medium operatively coupled to the one or more processors, a client profile for the at least one client, the client profile including the at least one of the created classes of assets, liabilities, income, expenses, or financial goals for the at least one client;
generate one or more initial financial planning recommendations and an initial financial plan for the at least client, the initial financial planning recommendations and the initial financial plan including calculations, performed by the one or more processors, of income and spending over a specified period of years, calculations, performed by the one or more processors, of an allocation of funds between the created classes of assets, liabilities, and expenses within the initial financial plan to at least one of maintain or achieve the financial goals of the at least one client, and store within non-transitory, computer readable storage medium the generated one or more initial financial planning recommendations and the initial financial plan in the client profile;
update, by the one or more processors, the stored client profile for the at least one client upon receipt of at least one of new values for the at least one of the created classes of assets, liabilities, income, expenses, or financial goals for the at least one client or a request, generated by at least one of the one or more processors, by recalculating the income and spending over the specified period of years and recalculating the allocation of funds to generate updated financial planning recommendations and an updated financial plan based on the new values to at least one of maintain the created financial goals or new financial goals for the at least one client; and
host, by the one or more processors, a plurality of GUIs for monitoring and updating at least one of the stored client profile or the one or more initial and updated financial planning recommendations and the initial and update financial plan for the at least one client;
monitor, by at least one of the one or more processors, by invoking one of the plurality of GUIs, the client profile and progress of the one or more initial and updated financial planning recommendations and the initial and updated financial plan toward the created financial goals or the new financial goals for the at least one client;
update, by the at least one of the one or more processors invoking one of the plurality of GUIs, a value of one or more of the created classes of assets, liabilities, income, expenses, or financial goals and generating the request to update the stored client profile to reflect the updated value;
simulate, by the at least one processor, performance of the client profile based on changing at least one attribute of at least one of the created classes of assets, liabilities, income, or expenses or a duration of the specified period of years;
based on the simulated performance, modify by the at least one processor the one or more initial or updated financial planning recommendations and the initial or updated financial plan with the at least one changed attribute to at least one of maintain the created financial goals or the new financial goals for the at least one client; and
generate, by the at least one processor, the request to update the stored client profile for the at least one client to include the modified one or more initial or updated financial planning recommendations and the initial or updated financial plan.
